(19) United States
(12) Patent Application Publication
(10) Pub. No.: US 2025/0133462 A1
(43) Pub. Date: Apr. 24, 2025

(54) WIRELESS COMMUNICATION USING MULTIPLE NETWORK SLICE SERVICES

(71) Applicant: QUALCOMM Incorporated, San Diego, CA (US)

(72) Inventors: Jianhua LIU, Beijing (CN); Miguel GRIOT, La Jolla, CA (US); Ozcan OZTURK, San Diego, CA (US); Peng CHENG, Beijing (CN); Stefano FACCIN, San Ysidro, CA (US)

(21) Appl. No.: 18/696,086

(22) PCT Filed: Nov. 19, 2021
(86) PCT No.: PCT/CN2021/131770

§ 371 Date: Mar. 27, 2024

(51) Int. Cl. H04W 36/00; H04W 76/15

(52) U.S. Cl. CPC H04W 36/13; H04W 36/008357; H04W 76/15

(57) ABSTRACT

Aspects relate to communication via multiple network slice services. A user equipment may support multiple network slice services (e.g., defined sets of network services and/or resources). At some point in time, the user equipment may communicate using a first network slice service provided by a first radio network entity (e.g., a first distributed unit, a first cell, a first base station, etc.). In addition, at some point in time, the user equipment may elect to use a second network slice service. In the event the first radio network entity is not available for the second network slice service, the user equipment may switch to a second radio network entity (e.g., a second distributed unit, a second cell, a second base station, etc.) to communicate using the second network slice service.

### TECHNICAL FIELD

The technology discussed below relates generally to wireless communication and, more particularly, to supporting different network slice services via different network entities.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A base station may schedule access to a cell to support access by multiple UEs. For example, a base station may allocate different resources (e.g., time domain and frequency domain resources) and provide different services for different UEs operating within a cell of the base station.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a method for wireless communication at a user equipment is disclosed. The method may include receiving configuration information for communicating using a first network slice service and a second network slice service, communicating first data for the first network slice service via a first radio network entity, establishing access to a second radio network entity as a result of the first radio network entity being unavailable for the second network slice service, and communicating second data for the second network slice service via the second radio network entity.

In some examples, a user equipment may include a transceiver, a memory, and a processor coupled to the transceiver and the memory. The processor may be configured to receive configuration information for communicating using a first network slice service and a second network slice service, communicate, via the transceiver, first data for the first network slice service via a first radio network entity, establish, via the transceiver, access to a second radio network entity as a result of the first radio network entity being unavailable for the second network slice service, and communicate, via the transceiver, second data for the second network slice service via the second radio network entity.

In some examples, a user equipment may include means for receiving configuration information for communicating using a first network slice service and a second network slice service, means for communicating first data for the first network slice service via a first radio network entity, means for establishing access to a second radio network entity as a result of the first radio network entity being unavailable for the second network slice service, and means for communicating second data for the second network slice service via the second radio network entity.

In some examples, an article of manufacture for use by a user equipment includes a non-transitory computer-readable medium having stored therein instructions executable by one or more processors of the user equipment to receive configuration information for communicating using a first network slice service and a second network slice service, communicate first data for the first network slice service via a first radio network entity, establish access to a second radio network entity as a result of the first radio network entity being unavailable for the second network slice service, and communicate second data for the second network slice service via the second radio network entity.

In some examples, a method for wireless communication at a network entity is disclosed. The method may include communicating first data for a first network slice service with a user equipment via a first radio network entity, receiving a message that identifies a second network slice service, and further identifies at least one other radio network entity, and communicating second data for the second network slice service with the user equipment via a second radio network entity selected from the at least one other radio network entity.

In some examples, a network entity may include a memory and a processor coupled to the memory. The processor may be configured to communicate first data for a first network slice service with a user equipment via a first radio network entity, receive a message that identifies a second network slice service, and further identifies at least one other radio network entity, and communicate second data for the second network slice service with the user equipment via a second radio network entity selected from the at least one other radio network entity.

In some examples, a network entity may include means for communicating first data for a first network slice service with a user equipment via a first radio network entity, means for receiving a message that identifies a second network slice service, and further identifies at least one other radio network entity, and means for communicating second data for the second network slice service with the user equipment via a second radio network entity selected from the at least one other radio network entity.

In some examples, an article of manufacture for use by a network entity includes a non-transitory computer-readable medium having stored therein instructions executable by one or more processors of the network entity to communicate first data for a first network slice service with a user equipment via a first radio network entity, receive a message that identifies a second network slice service, and further identifies at least one other radio network entity, and communicate second data for the second network slice service with the user equipment via a second radio network entity selected from the at least one other radio network entity.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic illustration of an example of wireless resources in an air interface utilizing orthogonal frequency divisional multiplexing (OFDM) according to some aspects.

FIG. 4 is a block diagram illustrating an example of a 5G wireless communication system according to some aspects.

FIG. 5 is a diagram illustrating an example of distributed entities in a wireless communication network according to some aspects.

FIG. 6 is a conceptual illustration of an example of user equipment (UE) deployment within a network slice configuration according to some aspects.

FIG. 7 is a conceptual illustration of another example of UE deployment within a network slice configuration according to some aspects.

FIG. 8 is a conceptual illustration of two examples of network architectures according to some aspects.

FIG. 9 is a signaling diagram illustrating an example of network slice service-related signaling for switching from a first slice served by a first distributed unit (DU) to a second slice served by a second DU according to some aspects.

FIG. 10 is a conceptual illustration of an example of network slice service-related protocol layer signaling according to some aspects.

FIG. 11 is a signaling diagram illustrating an example of network slice service-related signaling for resuming a previously suspended slice according to some aspects.

FIG. 12 is a signaling diagram illustrating an example of network slice service-related signaling for a scenario where a first slice and a second slice are mapped to the same protocol data unit (PDU) session according to some aspects.

FIG. 13 is a signaling diagram illustrating an example of network slice service-related signaling for switching from a first slice served by a first gNB to a second slice served by a second gNB according to some aspects.

FIG. 14 is a block diagram illustrating an example of a multiple access network according to some aspects.

FIG. 15 is a conceptual illustration of two examples of network slice service-related signaling for two network architectures according to some aspects.

FIG. 16 is a block diagram illustrating an example of a hardware implementation for a user equipment employing a processing system according to some aspects.

FIG. 17 is a flow chart illustrating an example method for communicating using multiple network slice services according to some aspects.

FIG. 18 is a block diagram illustrating an example of a hardware implementation for a network entity employing a processing system according to some aspects.

FIG. 19 is a flow chart illustrating an example method for communicating using multiple network slice services according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

Various aspects of the disclosure relate to communication via multiple network slice services (e.g., defined sets of network services and/or resources). A user equipment may support applications that communicate using different network slice services. At some point in time, an application on the user equipment may communicate using a first radio network entity. In some examples, a radio network entity may be a distributed unit, a cell, or a base station. Subsequently, an application on the user equipment may use a second network slice service. In the event the first radio network entity is not available for (e.g., does not support) the second network slice service, the user equipment may switch to a second radio network entity to communicate using the second network slice service.

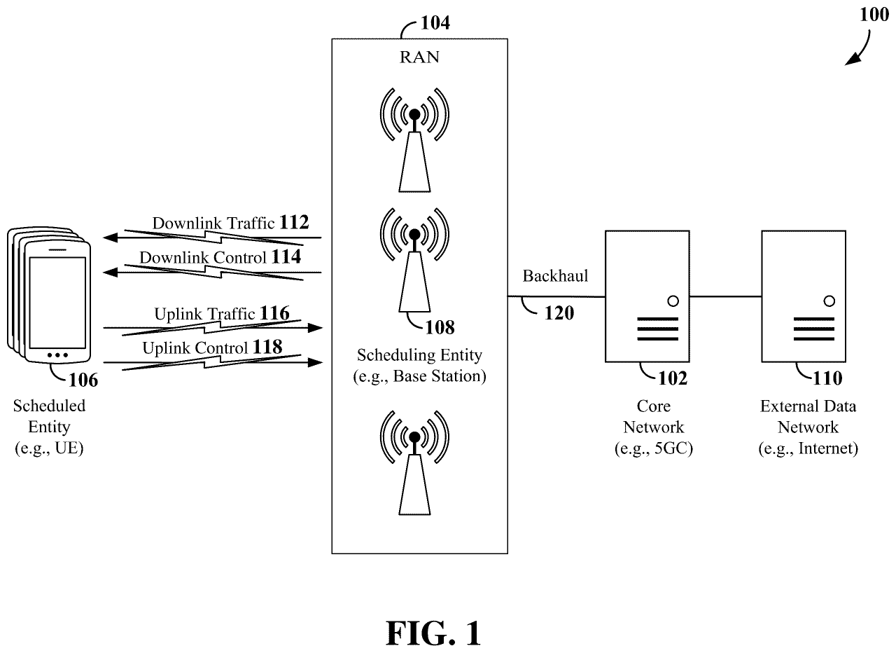

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (CUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

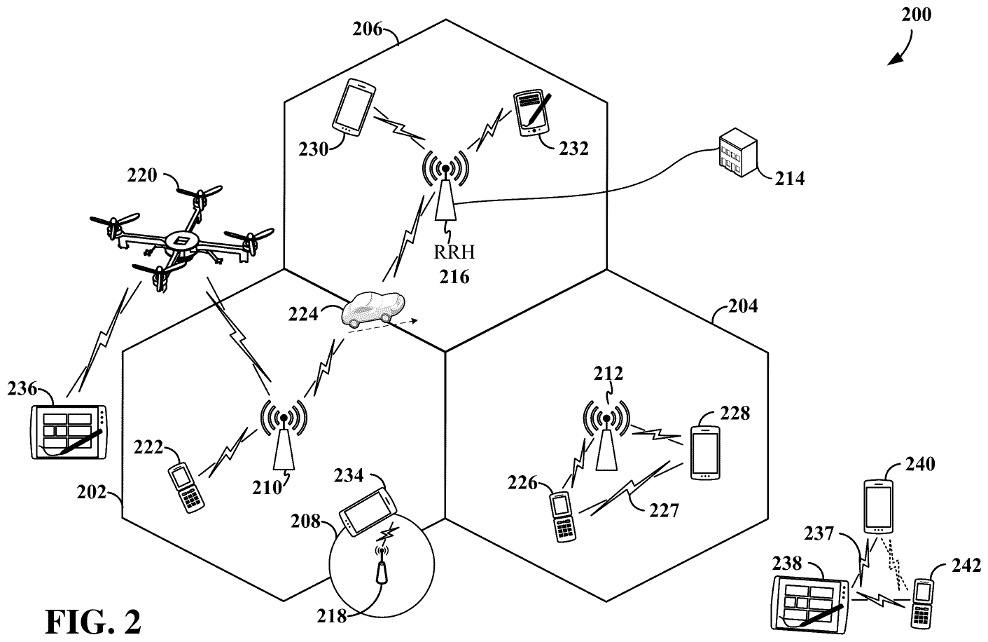

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

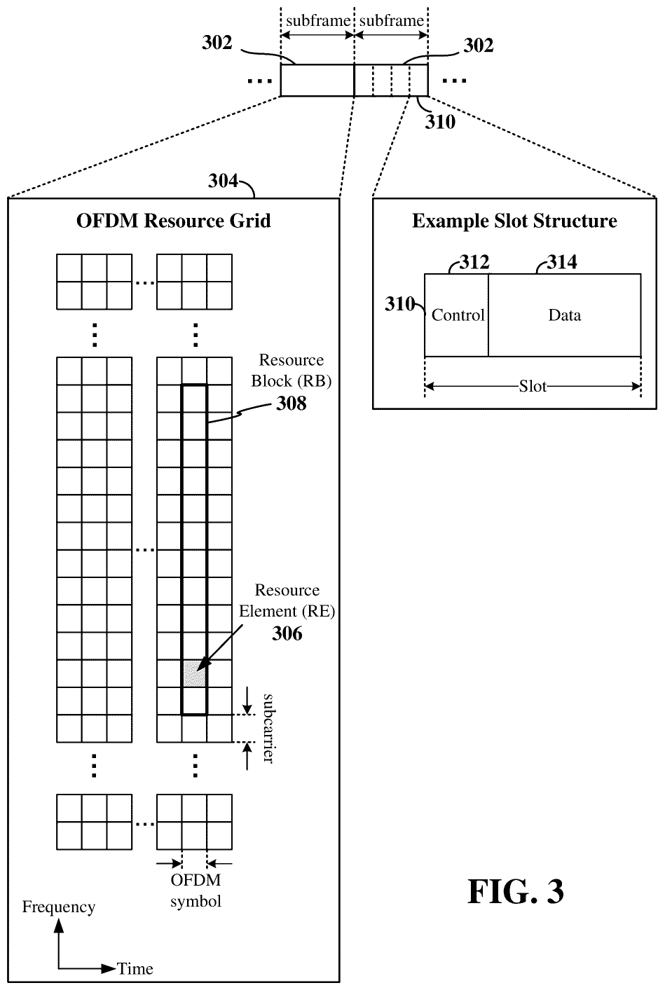

Various aspects of the present disclosure will be described with reference to an OFDM waveform, an example of which is schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an example subframe 302 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely an example, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs.

In an example of sidelink communication over a sidelink carrier via a proximity service (ProSc) PC5 interface, the control region 312 of the slot 310 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-3 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

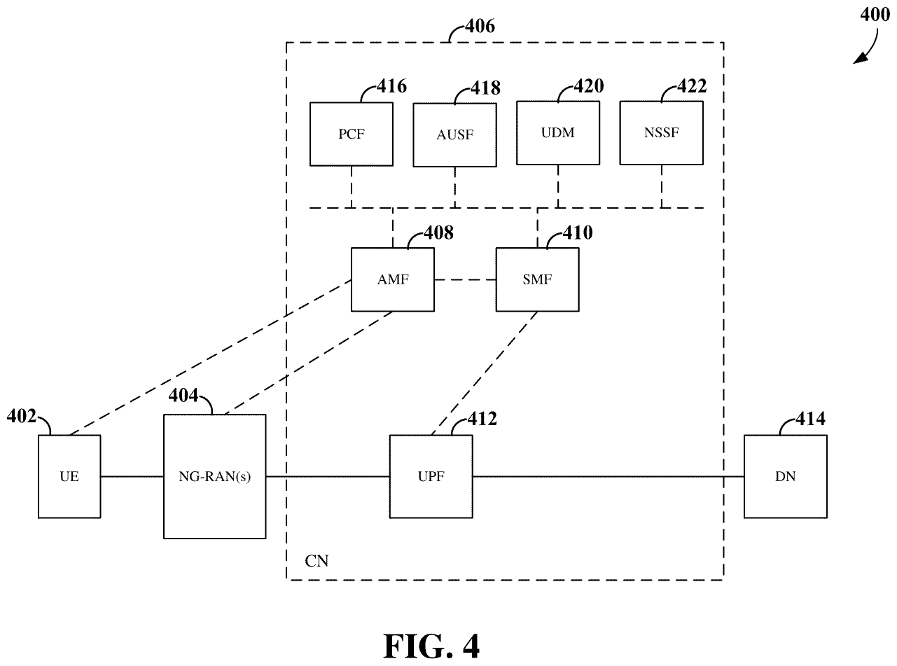

FIG. 4 illustrates an example of a 5G wireless communication system (5GS) 400. In some examples, the 5GS 400 may be the same wireless communication system 100 described above and illustrated in FIG. 1. The 5GS 400 includes a user equipment (UE) 402, a next generation radio access network (NG-RAN) 404, and a 5G core network 406. The UE 402 may correspond to any of the UEs or scheduled entities shown in any of FIGS. 1, 2, 4, 5, 6, 7, 9, 11, 12, 13, 14, 15, and 16. The NG-RAN 404 may correspond to any of the base stations or scheduling entities shown in any of FIGS. 1, 2, 4, 5, 9, 11, 12, 13, 14, 15, and 18.

The core network 406 may include, for example, an access and mobility management function (AMF) 408, a session management function (SMF) 410, and a user plane function (UPF) 412. The AMF 408 and the SMF 410 employ control plane (e.g., non-access stratum (NAS)) signaling to perform various functions related to mobility management and session management for the UE 402. For example, the AMF 408 provides connectivity, mobility management and authentication of the UE 402, while the SMF 410 provides session management of the UE 402 (e.g., processes signaling related to protocol data unit (PDU) sessions between the UE 402 and an external data network (DN) 414). The UPF 412 provides user plane connectivity to route 5G (NR) packets to/from the UE 402 via the NG-RAN 404.

The core network 406 may further include other functions, such as a policy control function (PCF) 416, authentication server function (AUSF) 418, unified data management (UDM) 420, network slice selection function (NSSF) 422, and other functions (not illustrated, for simplicity). The PCF 416 provides policy information (e.g., rules) for control plane functions, such as network slicing, roaming, and mobility management. In addition, the PCF 416 supports 5G quality of service (QOS) policies, network slice policies, and other types of policies. The AUSF 418 performs authentication of UEs 402. The UDM 420 facilitates the generation of authentication and key agreement (AKA) credentials, performs user identification and manages subscription information and UE context. In some examples, the AMF 408 includes a co-located security anchor function (SEAF) that allows for re-authentication of the UE 402 when the UE 402 moves between different NG-RANs 404 without having to perform a complete authentication process with the AUSF 418. The NSSF 422 redirects traffic to a network slice. Network slices may be defined, for example, for different classes of subscribers or use cases, such as smart home, Internet of Things (IoT), connected car, smart energy grid, etc. Each subscriber or use case may receive a unique set of optimized resources and network topology (e.g., a network slice) to meet the requirements (e.g., connectivity, speed, power, and/or capacity requirements) of the subscriber or use case.

To establish an NR SA connection to the 5G core network 406 via the NG-RAN 404, the UE 402 may transmit a registration request and a PDU session establishment request to the 5G core network 406 via the NG-RAN 404. The AMF 408 and the SMF 410 may process the registration request and the PDU session establishment request and establish a PDU session between the UE 402 and the external DN 414 via the UPF 412. A PDU session may include one or more sessions (e.g., data sessions or data flows) and may be served by multiple UPFs 412 (only one of which is shown for convenience). Examples of data flows include, but are not limited to, Internet Protocol (IP) flows, Ethernet flows, and unstructured data flows.

In some examples, a RAN may employ a distributed architecture where the functionality of a network node (e.g., incorporating modem functionality and/or other functionality) may be split among one or more control units and one or more distributed units (which may also be referred to as data units). For example, a network node may include one or more control units, each of which supports multiple distributed units. Each distributed unit may, in turn, support one or more radio units. A control unit, a distributed unit, and a radio unit provide different communication protocol layer functionality and other related functionality.

A network node may communicate with a core network via a backhaul link and communicate with at least one radio unit via at least one fronthaul link. In some examples, a network node may include at least one control unit and at least one distributed unit that communicate via at least one midhaul link.

In some examples, a control unit is a logical node that hosts a packet data convergence protocol (PDCP) layer, a radio resource control (RRC) layer, a service data adaptation protocol (SDAP) layer and other control functions. A control unit may also terminate interfaces (e.g., an E1 interface, an E2 interface, etc.) to network nodes (e.g., nodes of a core network). In addition, an F1 interface may provide a mechanism to interconnect a control unit (e.g., the PDCP layer and higher layers) and a distributed unit (e.g., the radio link control (RLC) layer and lower layers). In some aspects, an F1 interface may provide control plane and user plane functions (e.g., interface management, system information management, UE context management, RRC message transfer, etc.). For example, the F1 interface may support F1-C on the control plane and F1-U on the user plane. F1AP is an application protocol for F1 that defines signaling procedures for F1 in some examples.

In some examples, a distributed unit is a logical node that hosts an RLC layer, a medium access control (MAC) layer, and a high physical (PHY) layer based on a lower layer functional split. In some aspects, a distributed unit may control the operation of at least one radio unit. A distributed unit may also terminate interfaces (e.g., F1, E2, etc.) to the control unit and/or other network nodes. In some examples, a high PHY layer includes portions of the PHY processing such as forward error correction 1 (FEC 1) encoding and decoding, scrambling, modulation, and demodulation.

In some examples, a radio unit is a logical node that hosts low PHY layer and radio frequency (RF) processing based on a lower layer functional split. In some examples, a radio unit may be similar to a 3GPP transmit receive point (TRP) or remote radio head (RRH), while also including the low PHY layer. In some examples, a low PHY layer includes portions of the PHY processing such as fast Fourier transform (FFT), inverse FFT (iFFT), digital beamforming, and physical random access channel (PRACH) extraction and filtering. The radio unit may also include a radio chain for communicating with one or more UEs.

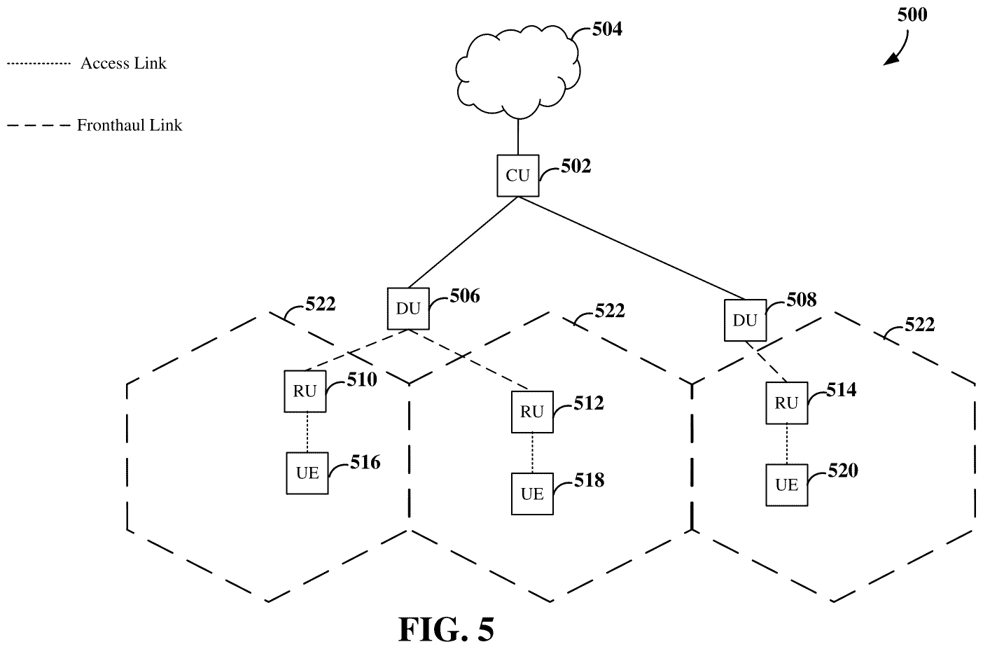

FIG. 5 is a diagram illustrating an example of a RAN 500 including distributed entities according to some aspects. The RAN 500 may be similar to the radio access network 200 shown in FIG. 2, in that the RAN 500 may be divided into a number of cells (e.g., cells 522) each of which may be served by respective network nodes (e.g., control units, distributed units, and radio units). The network nodes may constitute access points, base stations (BSs), eNBs, gNBs, or other nodes that utilize wireless spectrum (e.g., the radio frequency (RF) spectrum) and/or other communication links to support access for one or more UEs located within the cells.

In the example of FIG. 5, a control unit (CU) 502 communicates with a core network 504 via a backhaul link, and communicates with a first distributed unit (DU) 506 and a second distributed unit 508 via respective midhaul links. The first distributed unit 506 communicates with a first radio unit (RU) 510 and a second radio unit 512 via respective fronthaul links. The second distributed unit 508 communicates with a third radio unit 514 via a fronthaul link. The first radio unit 510 communicates with at least one UE 516 via at least one RF access link. The second radio unit 512 communicates with at least one UE 518 via at least one RF access link. The third radio unit 514 communicates with at least one UE 520 via at least one RF access link.

A wireless communication network may support different types of services. For example, a network may carry traffic with different priorities, traffic with different latency requirements (e.g., IoT traffic versus voice-over-Internet-protocol (VOIP) traffic, etc.), traffic with different bandwidth requirements, traffic with different throughput requirements, and so on. In some examples, these different types of services may correspond to different network slices (e.g., one “slice” of the network supports one service, another “slice” of the network supports another service, and so on). In some aspects, a network slice may refer to a set of network entities that can provide a particular service for a UE. In some aspects, a network slice may refer to a logical network that supports certain capabilities and that has certain characteristics.

In some examples, network slices are negotiated through the use of a NAS Registration procedure. Different types of network slices may be defined by corresponding network slice selection assistance information (NSSAI). For example, a given network slice may be identified by a single NSSAI (S-NSSAI). A set of S-NSSAIs may be referred to, for convenience, simply as an NSSAI. In some examples, an S-NSSAI may include a slice/service type (SST) which may specify the features and services of the network slice. In some examples, an S-NSSAI may include a slice differentiator (SD) that may, for example, distinguish network slices that have the same SST. Examples of SSTs include enhanced mobile broadband (eMBB), ultra-reliable low-latency communication (URLLC), and massive IoT (MIOT). Other types of SSTs may be defined as well.

To support different network slice services (e.g., different services associated with different network slices), a network may provide appropriate functionality associated with one or more cells to handle the requirements of the different services. However, a given network might not support all types of network slices in a homogeneous manner.

In some scenarios, the availability of cell on a certain frequency might not be homogeneous across a network. For example, in an area with high user density, a network may deploy cells on all available frequency bands. In contrast, only a subset of the available frequency bands may be deployed in an area with lower user density (e.g., to conserve network resources). Moreover, different cells may support different network slices. Thus, a UE may move from one area where some frequency bands are used to deploy cells supporting one or more network slices to an area where other frequency bands are used to deploy cells supporting one or more network slices.

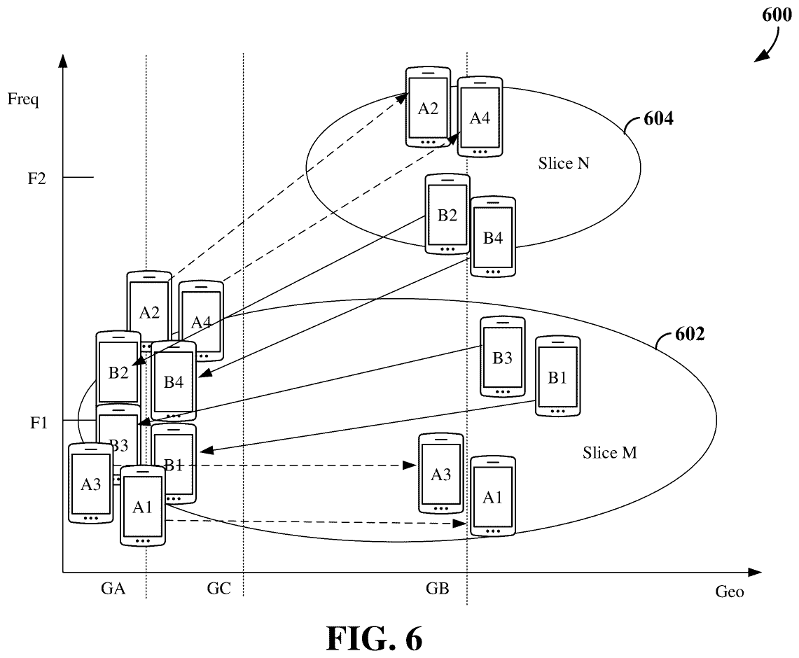

An example of this scenario is shown in the network slice configuration diagram 600 of FIG. 6 where a network supports a first network slice 602 (slice M) on a first frequency band F1 in a first geographical area (e.g., corresponding to geographical areas GA and GC). In addition, in a second geographical area (e.g., corresponding to geographical area GB), the network may support both the first network slice on the first frequency band F1 and a second network slice 604 (slice N) on a second frequency band F2.

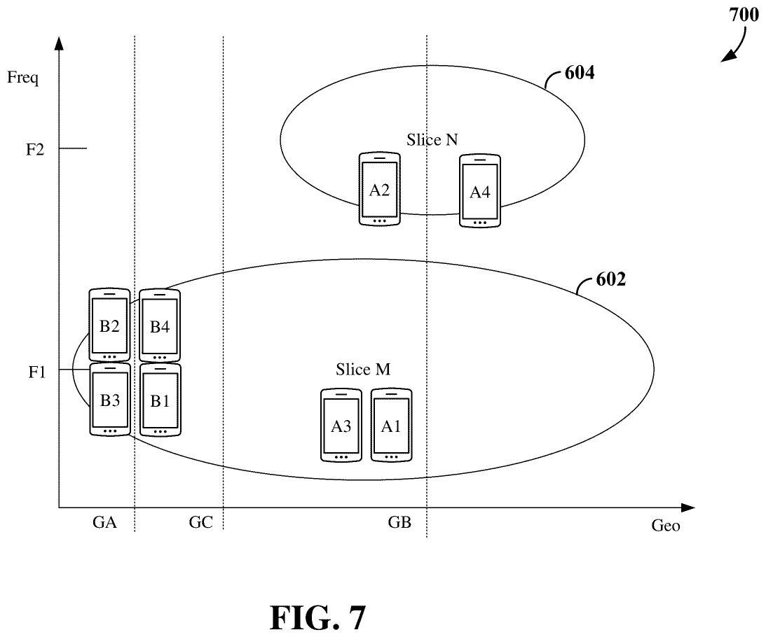

As shown in FIG. 6, the UEs (e.g., UEs A1, A2, A3, A4, B1, B2, B3, and B4) that use these network slices may move between the geographical areas. For example, the UEs A1 and A3 may move from the geographical area GA (where the UEs A1 and A3 use slice M) to the geographical area GB (where the UEs A1 and A3 continue to use slice M). In addition, the UEs A2 and A4 may move from the geographical area GA (where the UEs A2 and A4 use slice M) to the geographical area GB (where the UEs A2 and A4 use slice N). Also, the UEs B1 and B3 may move from the geographical area GB (where the UEs B1 and B3 use slice M) to the geographical area GA (where the UEs B1 and B3 continue to use slice M). In addition, the UEs B2 and B4 may move from the geographical area GB (where the UEs B2 and B4 use slice N) to the geographical area GA (where the UEs B2 and B4 use slice M). The network slice configuration diagram 700 of FIG. 7 shows the locations of the UEs after these movements.

From the above, it may be seen that in some cases (e.g., when the UEs are in the geographical area GA), the UEs may only be able to use slice M. In contrast, in other cases (e.g., when the UEs are in the geographical area GB), the UEs may be able to use slice M and/or slice N. Thus, as a UE moves, the UE may switch from using one network slice to another network slice.

The disclosure relates in some aspects to attempting to make the amount time that a UE is not provided with a desired network slice as short as possible. For example, when a higher priority network slice (e.g., from the perspective of the UE) becomes available to the UE, the network may be configured to provide the higher priority network slice to the UE as soon as possible. In addition, this may be achieved while mitigating the impact on any applications that are using network slices (e.g., lower priority network slices) that are to be released.

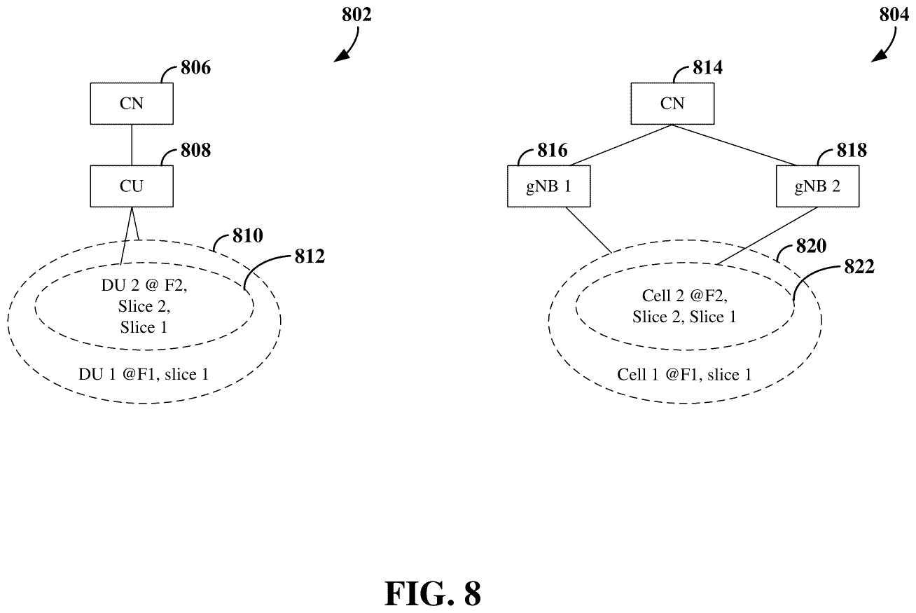

FIG. 8 illustrates two example network architectures that may support network slices according to some aspects. A first architecture 802 illustrates an example of a distributed network where control units (CUs) and distributed units (DUs) support network slices. A second architecture 804 illustrates an example of a network where gNBs support network slices.

In the first architecture 802, a core network (CN) 806 communicates with a control unit (CU) 808 that controls a first DU (DU 1) and a second DU (DU 2). The first DU is deployed to provide service 810 for a first network slice (slice 1) on frequency band F1. The second DU is deployed to provide service 812 for slice 1 and a second network slice (slice 2) on frequency band F2.

In the second architecture 804, a core network (CN) 814 communicates with a first gNB (gNB 1) 816 and a second gNB (gNB 2) 818. The first gNB 816 is deployed to provide service 820 for slice 1 on frequency band F1. The second gNB 818 is deployed to provide service 822 for slice 1 and slice 2 on frequency band F2.

In the scenarios shown in FIG. 8, a UE can be authorized to access to multiple network slices of one operator. For example, a UE may be configured to use two network slices simultaneously.

In some scenarios, however, a UE might not be able to use two network slices simultaneously (e.g., in the scenarios of FIG. 6). In this case, a UE may switch access from one network slice to another network slice. The disclosure relates in some aspects to different network slice-triggered cell handover procedures (e.g., for cells served by DUs and/or gNBs). In some aspects, these procedures may minimize service interruption during network slice switching.

A first procedure relates to a network slice triggered DU change. In this procedure, a preferred network slice (e.g., a network slice service preferred by a UE) triggers a DU change (e.g., from DU 1 to DU 2) whereby, during the DU change, a new PDU session is established or activated for the preferred network slice (e.g., slice 2) with dedicated radio bearer (DRB) configurations. In addition, the source UE context may be suspended or resumed for switching back to the original network slice (e.g., slice 1).

A second procedure relates to using a single PDU session that is associated with multiple network slices. Here, the PDU session can be remapped to a different network slice if there is a change to a different network slice. In some examples, a PDU session modification procedure is used to change the corresponding network slice information. In this case, when the availability of a preferred network slice triggers a DU change, the PDU session may be modified to map with the preferred network slice (e.g., slice 2), and the corresponding DRB configurations are established. In addition, the source UE context may be suspended or resumed for switching back to the original network slice (e.g., slice 1).

A third procedure relates to an enhanced measurement report mechanism. In some aspects, this procedure may allow a UE to request the network to handover the UE to a cell that supports a preferred network slice.

A fourth procedure relates to a PDU session for multiple network slices where the PDU session supports multiple access. For example, one PDU session may be associated with two network slices and separate access resource may be allocated for the two network slices. In this case, during network slice switching, the impact on the NAS PDU session may be negligible (e.g., there may be no signaling impact).

In some examples, the first procedure may be employed in the first architecture 802 of FIG. 8 where a first DU (DU 1) @ F1 supports slice 1, and a second DU (DU 2) @F2 supports slice 2 (and, optionally, slice 1 as well).

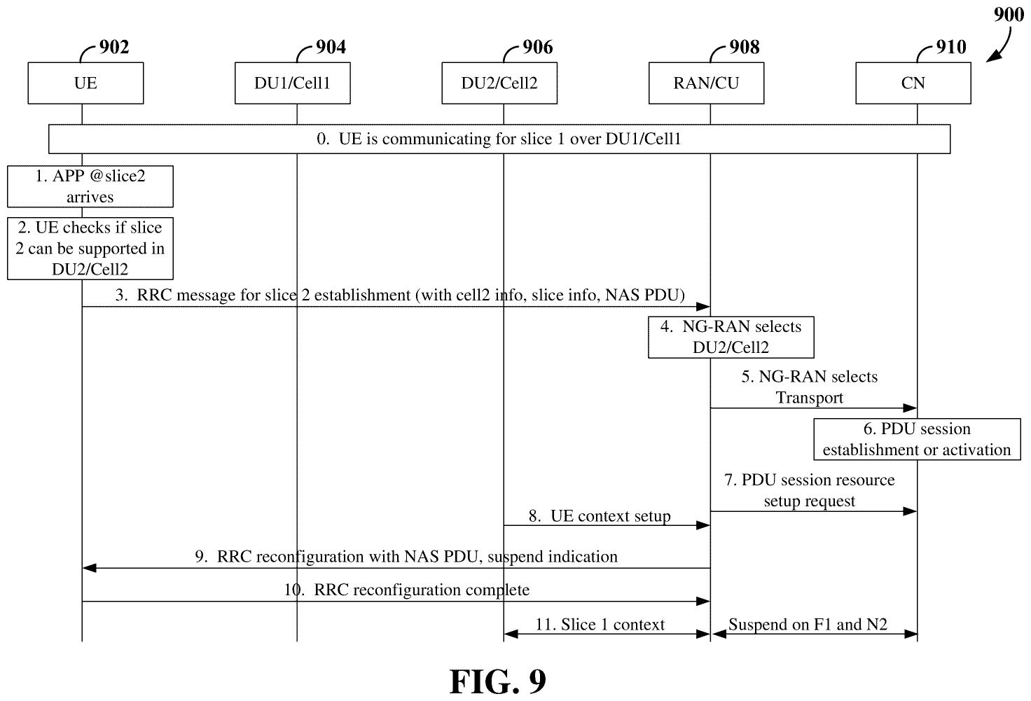

FIG. 9 is a signaling diagram 900 illustrating an example of network slice-related signaling for the first procedure in a wireless communication system including a user equipment (UE) 902, a first DU that serves a first cell (DU1/cell1 904), a second DU that serves a second cell (DU2/cell2 906), a RAN/CU 908, and a CN 910. In some examples, the UE 902 may correspond to any of the UEs or scheduled entities shown in any of FIGS. 1, 2, 4, 5, 6, 7, 11, 12, 13, 14, 15, and 16. In some examples, the DU1/cell1 904 and the DU2/cell2 906 may correspond to any of the DUs, base stations, or scheduling entities shown in any of FIGS. 1, 2, 4, 5, 11, 12, 13, 14, 15, and 18. In some examples, the RAN/CU 908 may correspond to any of the RAN nodes, CU nodes, or scheduling entities shown in any of FIGS. 1, 2, 4, 5, 11, 12, 13, 14, 15, and 18. In some examples, the CN 910 may correspond to any of the CN entities shown in any of FIGS. 1, 2, 4, 5, 11, 12, 13, 14, 15, and 18.

At #0 of FIG. 9, the UE 902 is communicating with the network for slice 1 over DU1/Cell1 904. At #1-#2 of FIG. 9, the UE 902 detects that a slice 2 service arrives (e.g., based on UE route selection policy (URSP)). For example, an application on the UE 902 may invoke use of slice 2 and the UE 902 may detect that slice 2 can be supported in cell 2 based on system information (SI) that the UE 902 receives from DU2/cell2 906. At #3 of FIG. 9, the UE 902 sends an RRC message with cell 2 information (e.g., measurement results or an indication that the cell 2 link quality satisfies a configured threshold), slice 2 information, and a non-access stratum (NAS) PDU (e.g., a PDU session establishment request or service request) to the RAN/CU 908. At #4-#8 of FIG. 9, a PDU session is established or activated and the appropriate UE context is set up. In some examples, UE context may include, in part, a serving radio bearer (SRB), a dedicated radio bearer (DRB), and a backhaul (BH) RLC channel. At #9-#10 of FIG. 9, the UE 902 is configured for slice 2 service upon receiving an RRC reconfiguration message from the RAN/CU 908 where the corresponding RRC configuration includes a NAS PDU, including a bearer configuration for slice 2, and a suspend indication for slice 1 related access stratum (AS) context. At #11 of FIG. 9, the CU of RAN/CU 908 initiates a slice 1 context suspend operation (e.g., on the F1 and N2 interfaces). In some examples, if the DU2/cell2 906 supports slice 1 as well as slice 2, the CU can switch the slice 1 context to the DU2/cell2 906.

Thus, the first procedure may support restricted service triggered DU changes, and allow a UE to request the network to switch to another DU that supports the preferred network slice. Moreover, this procedure may establish or activate a PDU session for slice 2 during a DU change, thereby providing reduced signaling overhead.

In some examples of the first procedure, different PDU sessions are associated with different network slices. When the availability of a preferred network slice triggers a DU change, a UE may report candidate cells supporting slice 2. During the DU change that follows, a new PDU session is established or activated for slice 2 with appropriate DRB configurations. In addition, the source UE context may be suspended or resumed for switching back to the original network slice in some examples.

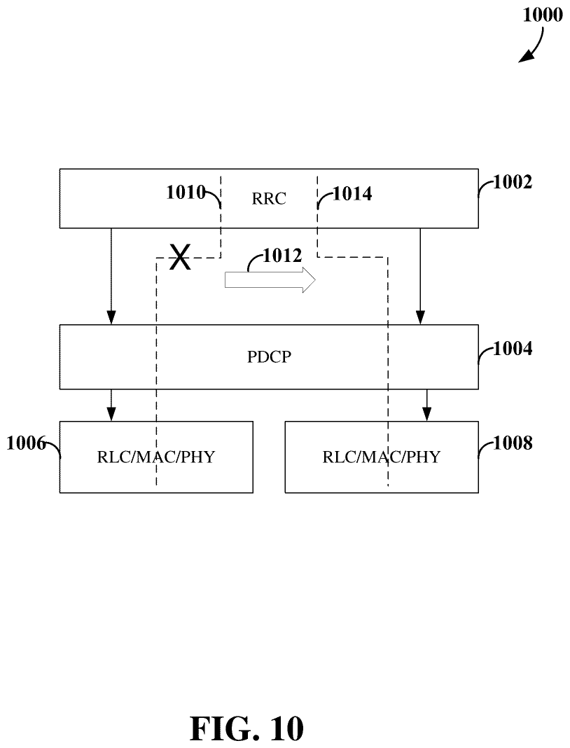

FIG. 10 is a protocol signaling diagram 1000 illustrating protocol signaling flows for different network slices. An RRC layer 1002 and a PDCP layer 1004 are shown along with an RLC/MAC/PHY layer 1006 for a first DU and an RLC/MAC/PHY layer 1008 for a second DU. The signaling flow 1010 is initially used for communicating data for a first network slice (slice 1) via the first DU. Subsequently, when a second network slice (slice 2) is needed (as represented by the arrow 1012), the signaling flow 1010 is terminated and the signaling flow 1014 is activated.

As discussed above, a UE may switch back to a prior network slice in some cases (e.g., when there is no more data for slice 2). Here, when the service for slice 2 is terminated (e.g., based on the RAN detecting that there is no more slice 2 data), the RAN can release the slice 2 context.

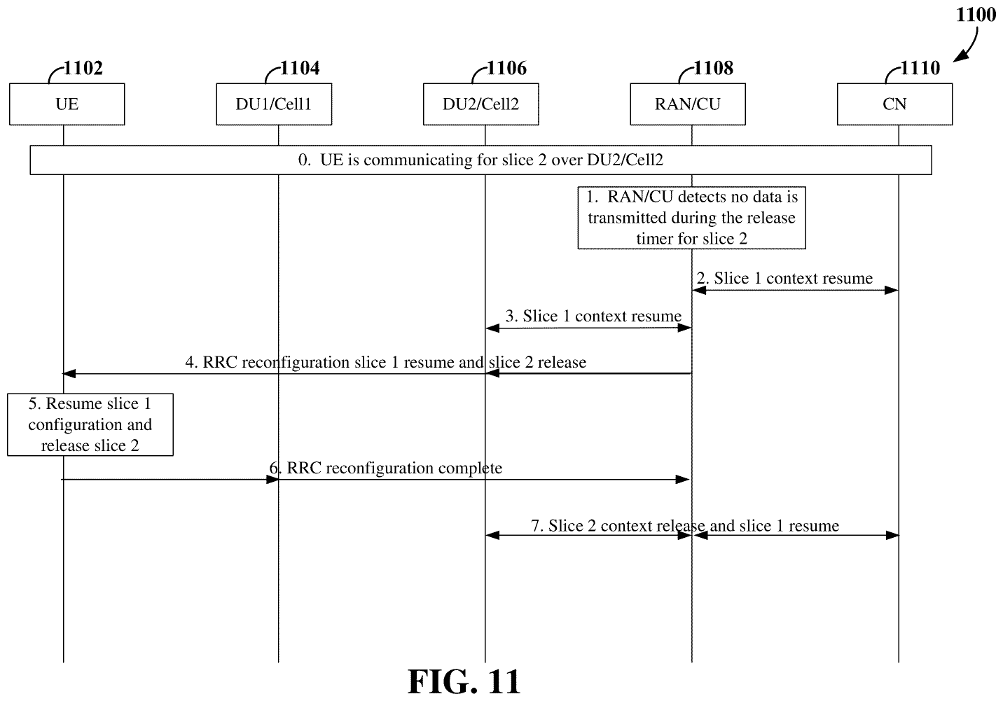

FIG. 11 is a signaling diagram 1100 illustrating an example of network slice switch-back related signaling for the first procedure in a wireless communication system including a user equipment (UE) 1102, a first DU that serves a first cell (DU1/cell1 1104), a second DU that serves a second cell (DU2/cell2 1106), a RAN/CU 1108, and a CN 1110. In some examples, the UE 1102 may correspond to any of the UEs or scheduled entities shown in any of FIGS. 1, 2, 4, 5, 6, 7, 9, 12, 13, 14, 15, and 16. In some examples, the DU1/cell1 1104 and the DU2/cell2 1106 may correspond to any of the DUs, base stations, or scheduling entities shown in any of FIGS. 1, 2, 4, 5, 8, 9, 12, 13, 14, 15, and 18. In some examples, the RAN/CU 1108 may correspond to any of the RAN nodes, CU nodes, base stations, or scheduling entities shown in any of FIGS. 1, 2, 4, 5, 8, 9, 12, 13, 14, 15, and 18. In some examples, the CN 1110 may correspond to any of the CN entities shown in any of FIGS. 1, 2, 4, 5, 8, 9, 12, 13, 14, 15, and 18.

At #0 of FIG. 11, the UE 1102 is communicating with the network for slice 2 over DU2/Cell2 1106. At #1 of FIG. 11, the CU of the RAN/CU 1108 may subsequently detect that no data has been transmitted for slice 2 during a corresponding release timer and, for the case where the context (e.g., AS context) for slice 1 has been suspended, the CU may elect to switch back to slice 1 service. At #2-#3 of FIG. 11, the CU requests the CN 1110 to resume slice 1 context using an N2 resume procedure. The CN 1110 requests the DU2/Cell2 to resume slice 1 context using an F1AP signaling exchange with a resume indication for slice 1. At #4-#6 of FIG. 11, the CU provides an RRC Reconfiguration to the UE 1102 over DU2/Cell2 1106, indicating release of the context for slice 2 and resume of the context for slice 1. The UE 1102 applies the configuration and releases the context (e.g., AS context) for slice 2. At #7 of FIG. 11, the CU releases the context for slice 2 and resumes the context for slice 1.

A determination by the CU to switch back to slice 1 may be based on one or more conditions. In some examples, the CU may elect to switch back to slice 1 when service for slice 2 is terminated.

In some examples, a CU may resume slice 1 by default, whereby #2 and #3 of FIG. 11 also occur by default. If the UE determines that there is no service for slice 1 in this case, in #6 of FIG. 11, the UE may indicate this condition to the CU that serves slice 1, and this CU may release the context for slice 1.

In some examples, during #2 of FIG. 11 when the CU attempts to resume slice 1 context, the CN 1110 can reject this resumption of slice 1 context if the CN 1110 determines that there is no data for slice 1. In some examples, the CN may determine that there is no slice 1 data based on buffered data, UE subscription information, or local policy.

In some examples, #2 of FIG. 11 may occur after #6 of FIG. 11. The CU may, by default, resume slice 1 context in #4 of FIG. 11, and the UE 1102 may indicate to the CN 1110 in #6 of FIG. 11 whether there is data for slice 1. The CU may then determine whether to resume slice 1 context in the CN 1110 and the DU for slice 1. If there is no data for slice 1, the UE 1102 may enter an IDLE state after #6 of FIG. 11 and release locally the slice 1 context.

In some examples, one or more of the CU and/or DU operations of FIG. 11 may be performed by a base station or other scheduling entity. For example, a gNB may determine whether to release the context for slice 2 and resume the context for slice 1.

As discussed above, the second procedure relates to a single PDU session that is associated with multiple network slices. In this case, the PDU session is not changed when there is a network slice change. In some aspects, the second procedure may be used in conjunction with the first procedure.

When one PDU session is associated with multiple network slices, the PDU session can be remapped to a different network slice if there is a network slice change. In some examples, a PDU session modification procedure is used to remap the network slice information. As discussed above, a UE may report candidate cells supporting slice 2. In this case, during a DU change, the PDU session may be modified to map with slice 2, and corresponding DRB configurations may be established. In addition, the source UE context may be suspended or resumed for switching back to the previous network slice.

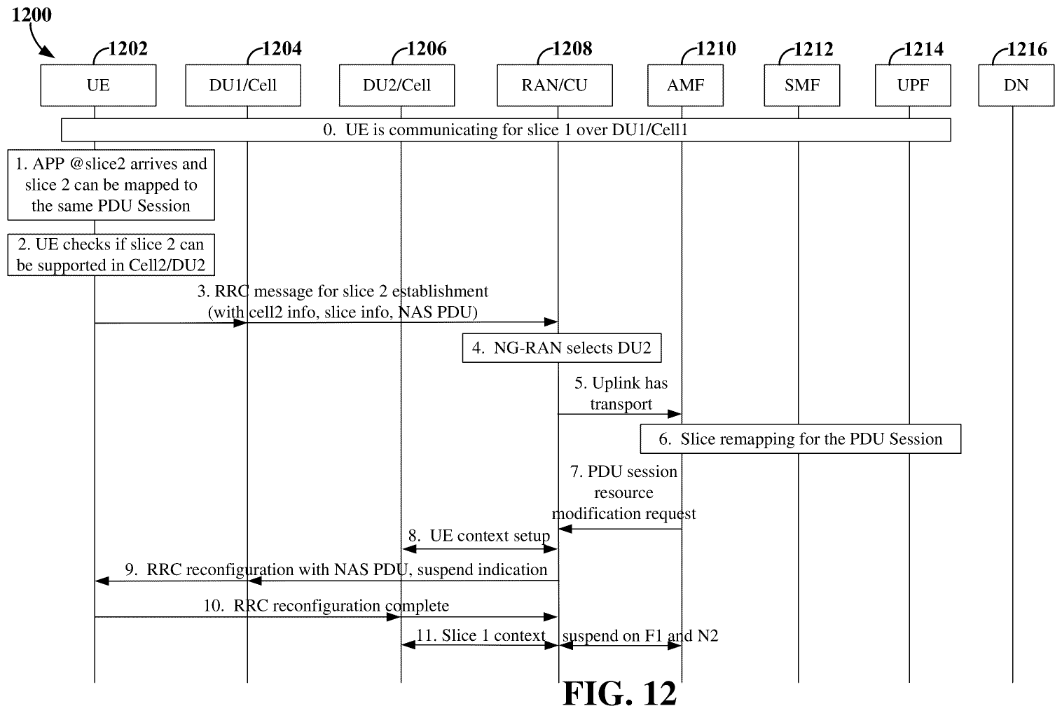

FIG. 12 is a signaling diagram 1200 illustrating an example of network slice-related signaling for the second procedure in a wireless communication system including a user equipment (UE) 1202, a first DU that serves a first cell (DU1/cell1 1204), a second DU that serves a second cell (DU2/cell2 1206), a RAN/CU 1208, CN entities (an AMF 1210, an SMF 1212, and a UPF 1214), and a DN 1216. In some examples, the UE 1202 may correspond to any of the UEs or scheduled entities shown in any of FIGS. 1, 2, 4, 5, 6, 7, 9, 11, 13, 14, 15, and 16. In some examples, the DU1/cell1 1204 and the DU2/cell2 1206 may correspond to any of the DUs, base stations, or scheduling entities shown in any of FIGS. 1, 2, 4, 5, 8, 9, 11, 13, 14, 15, and 18. In some examples, the RAN/CU 1208 may correspond to any of the RAN nodes, CU nodes, or scheduling entities shown in any of FIGS. 1, 2, 4, 5, 8, 9, 11, 13, 14, 15, and 18. In some examples, the AMF 1210 may correspond to any of the AMF entities shown in any of FIGS. 4, 14, and 15. In some examples, the SMF 1212 may correspond to any of the SMF entities shown in any of FIGS. 4, 14, and 15. In some examples, the UPF 1214 may correspond to any of the UPF entities shown in any of FIGS. 4, 14, and 15. In some examples, the DN 1216 may correspond to any of the DN nodes shown in any of FIGS. 1, 2, 4, and 14.

At #0 of FIG. 12, the UE 1202 is communicating with the network for slice 1 over DU1/Cell1 1206. In some examples, the UE is configured with a rule (e.g., a URSP rule) specifying that one PDU session can associate with multiple network slices. At #1 of FIG. 12, service for slice 2 arrives at the UE 1202 (e.g., as discussed above) whereby slice 2 can be associated with the same PDU session as slice 1 based on the configured rule. At #2 of FIG. 12, the UE 1202 checks whether slice 2 can be supported in DU2/Cell2 1206 (e.g., based on received SI), and checks whether the cell 2 link quality is enough good (e.g., meets the threshold configured by network). At #3 of FIG. 12, the UE 1202 sends an RRC message with cell 2 information (e.g., measurement results), slice 2 information, and a NAS PDU to the RAN/CU 1208. Depending on #1 of FIG. 12, the NAS PDU could be a PDU session modification request, including a PDU session identifier (ID), and a remapped slice 2 (if a URSP with multiple network slices associated one PDU session is configured).

At #4-#5 of FIG. 12, the RAN/CU 1208 selects DU 2 for slice 2. At #6 of FIG. 12, the CN may remap the PDU session to slice 2 as follows. The AMF 1210 selects the corresponding SMF 1212 according to the PDU session ID. The SMF 1212 modifies the network slice information to the PDU session, and selects the corresponding UPF 1214 (e.g., if the SMF 1212 supports slice 1 and slice 2). In some examples, if a new SMF is selected, a new PDU session is established for slice 2 and configured to the UE 1202. At #7 of FIG. 12, the AMF 1210 sends a PDU session resource modification request to the RAN/CU 1208. #8-#11 of FIG. 12 may be similar to #8-#11 of FIG. 9.

From the above, it may be seen that a new PDU session need not be established or activated for different network slices. In some aspects, this may reduce NAS signaling, and reduce network slice switching time.

As mentioned above, the third procedure relates to network slice switching between different gNBs.

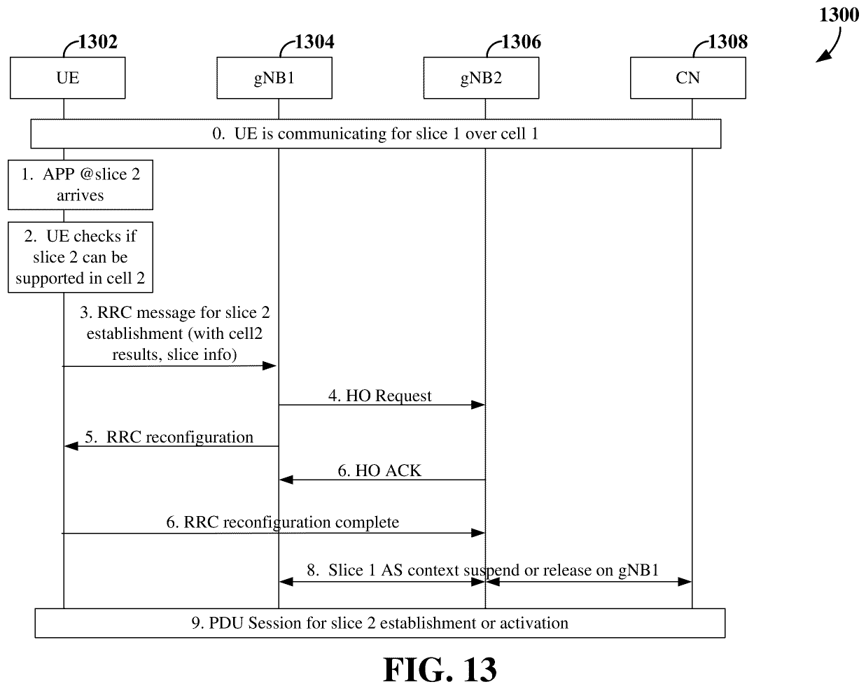

FIG. 13 is a signaling diagram 1300 illustrating an example of network slice-related signaling for the third procedure in a wireless communication system including a user equipment (UE) 1302, a first gNB (gNB1 1304), a second gNB (gNB2 1306), and a CN 1308. In some examples, the UE 1302 may correspond to any of the UEs or scheduled entities shown in any of FIGS. 1, 2, 4, 5, 6, 7, 9, 11, 12, 14, 15, and 16. In some examples, the gNB1 1304 and the gNB2 1306 may correspond to any of the base stations or scheduling entities shown in any of FIGS. 1, 2, 4, 5, 8, 9, 11, 12, 14, 15, and 18. In some examples, the CN 1308 may correspond to any of the CN entities shown in any of FIGS. 1, 2, 4, 5, 8, 9, 11, 12, 14, 15, and 18.

At #0 of FIG. 13, the UE 1302 is communicating with the network for slice 1 over gNB1 1304 (cell 1). At #1-#2 of FIG. 13, the UE 1302 detects that the slice 2 service arrives (e.g., based on the URSP). For example, an application on the UE 1302 may invoke use of slice 2 and the UE 1302 may detect that slice 2 can be supported in cell 2 based on system information (SI) that the UE 1302 receives from gNB2 1306 (cell 2). At #3 of FIG. 13, the UE 1302 sends an RRC message to the gNB1 1304 with cell 2 information (e.g., measurement results or an indication that the cell 2 link quality satisfies a configured threshold) and optionally reports slice 2 information. At #4-#9 of FIG. 13, a handover to the gNB 2 1306 is performed whereby the context (e.g., AS context) for network slice 1 is suspended or released on the gNB1 1304 and a PDU session for slice 2 is established or reactivated on the gNB2 1306.

In some examples, at #3 of FIG. 13, the UE 1302 reports a list of cells satisfying a configured threshold, and indicates slice 2 information. This configured threshold may be specific for triggering a measurement report to switch to another network slice. Upon receiving the RRC message from the UE 1302, the gNB1 1304 selects gNB2 1306 supporting slice 2 with the available cells indicated by the UE 1302.

In some examples, at #3 of FIG. 13, the UE 1302 reports a list of cells satisfying the configured threshold and supporting slice 2. A difference with the example of the preceding paragraph is that in this case the UE 1302 will determine whether the candidate cells support slice 2, and UE 1302 only reports slice 2 capable cells to the gNB1 1304. The gNB1 1304 may then select the gNB2 1306 according to the cell information.

In some examples, at #3 of FIG. 13, the UE 1302 reports a list of cells and measurement results, where all of the reported cells support slice 2. In this case, the gNB1 1304 may select the gNB2 1306 according to the cell information, the measurement results, and the supported network slice information. In addition, a specific threshold for different network slice switching may be configured to the UE 1302.

From the above, it may be seen that the disclosed enhanced measurement reporting may enable a UE to request the network to handover the UE to a cell that supports a preferred network slice.

As discussed above, the fourth procedure relates to a PDU session for multiple network slices, where the PDU session supports multiple access. For example, the PDU session may support user-plane resources on multiple access networks (e.g., where one access network supports 3GPP access, and another access network supports non-3GPP access).

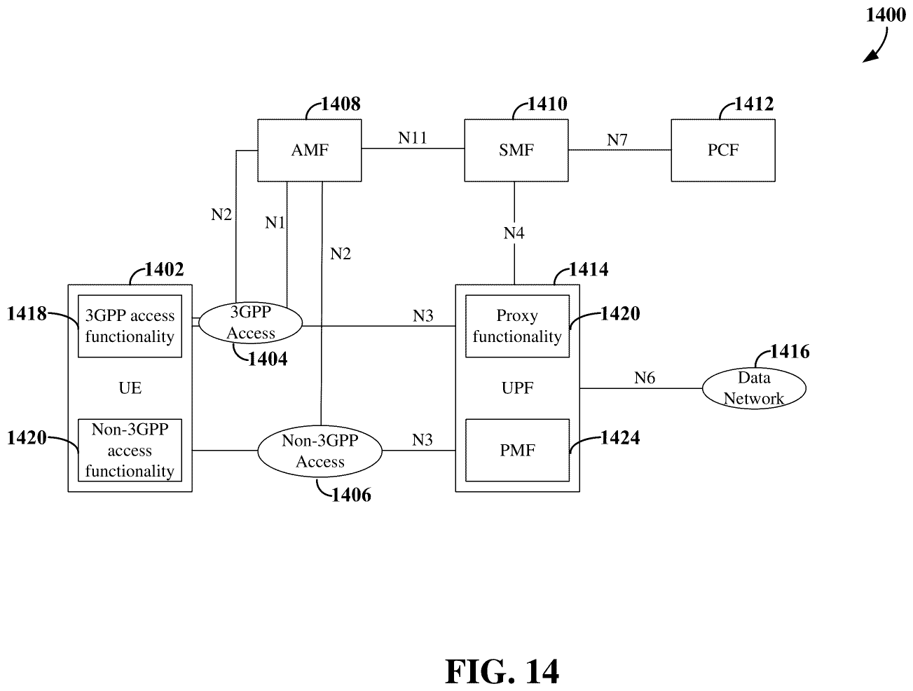

FIG. 14 is a block diagram illustrating an example of a multiple access network 1400 that supports 3GPP access and non-3GPP access (e.g., Wi-Fi, or some other type of non-3GPP access). The network 1400 includes a user equipment (UE) 1402, a 3GPP access node 1404, a non-3GPP access node 1404, an AMF 1408, an SMF 1410, a PCF 1412, and a UPF 1414 that provides access to a DN 1416. Example interfaces (N1, N2, N3, N4, N6, N7, and N11) used for communication among the various entities are also shown. In some examples, the UE 1402 may correspond to any of the UEs or scheduled entities shown in any of FIGS. 1, 2, 4, 5, 6, 7, 9, 11, 12, 13, 15, and 16. In some examples, the 3GPP access node 1404 may correspond to any of the base stations, scheduling entities, or DUs shown in any of FIGS. 1, 2, 4, 5, 8, 9, 11, 13, 15, and 18. In some examples, the AMF 1408 may correspond to any of the AMF entities shown in any of FIGS. 4, 12, and 15. In some examples, the SMF 1410 may correspond to any of the SMF entities shown in any of FIGS. 4, 12, and 15. In some examples, the PCF 1412 may correspond to the PCF 416 shown in FIG. 4. In some examples, the UPF 1414 may correspond to any of the UPF entities shown in any of FIGS. 4, 12, and 15. In some examples, the DN 1416 may correspond to any of the DN nodes shown in any of FIGS. 1, 2, 4, and 12.

The UE 1402 includes 3GPP access functionality 1418 for communicating with the 3GPP access node 1404 and non-3GPP access functionality 1420 for communicating with the non-3GPP access node 1406. The UPF 1414 includes proxy functionality 1422 and a path management function (PMF) 1424 for supporting the 3GPP access and the non-3GPP access. After the establishment of a PDU session, and when there are user-plane resources on all access networks, the UE 1402 and the UPF 1414 may apply network-provided policy and consider local conditions (e.g., network interface availability, signal loss conditions, user preferences, etc.) to decide how to distribute the UE traffic across the access networks.

In some examples, a PDU session may support user-plane resources on multiple access networks including the two architectures shown in FIG. 8.

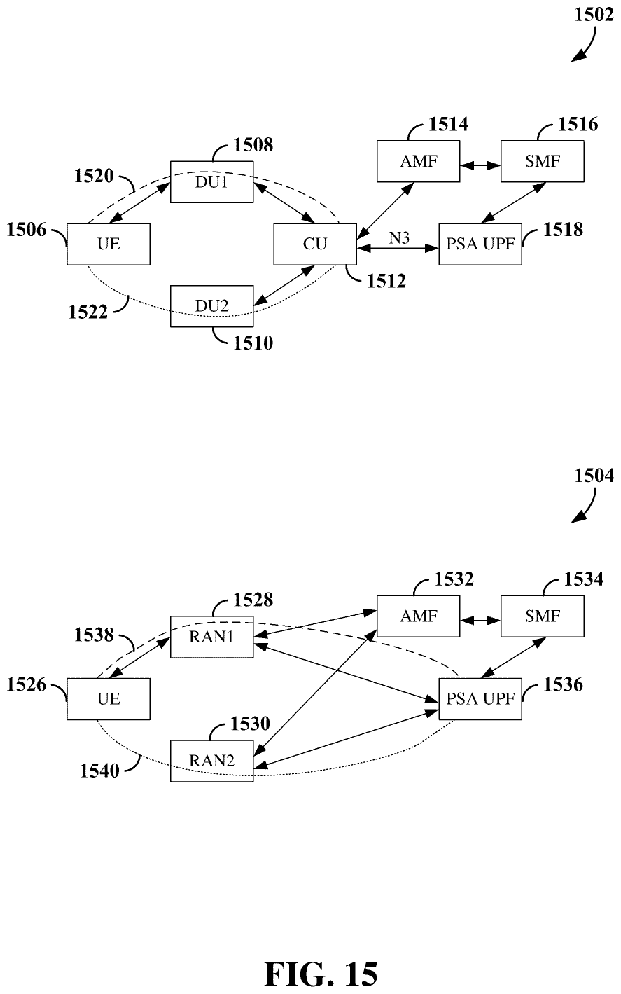

FIG. 15 illustrates a wireless communication system 1502 corresponding to the first architecture 802 of FIG. 8 and a wireless communication system 1504 corresponding to the second architecture 804 of FIG. 8.

The wireless communication system 1502 includes a user equipment (UE) 1506, a first DU 1508, a second DU 1510, a CU 1512, an AMF 1514, an SMF 1516, and a PDU session anchor (PSA) UPF 1518. In some examples, the UE 1506 may correspond to any of the UEs or scheduled entities shown in any of FIGS. 1, 2, 4, 5, 6, 7, 9, 11, 12, 13, 14, and 16. In some examples, the first DU 1508 and the second DU 1510 may correspond to any of the DUs, base stations, or scheduling entities shown in any of FIGS. 1, 2, 4, 5, 8, 9, 11, 12, 13, 14, and 18. In some examples, the CU 1512 may correspond to any of the CU nodes or scheduling entities shown in any of FIGS. 1, 2, 4, 5, 8, 9, 11, 12, 13, 14, and 18. In some examples, the AMF 1514 may correspond to any of the AMF entities shown in any of FIGS. 4, 12, and 14. In some examples, the SMF 1516 may correspond to any of the SMF entities shown in any of FIGS. 4, 12, and 14. In some examples, the UPF 1518 may correspond to any of the UPF entities shown in any of FIGS. 4, 12, and 14.

In the wireless communication system 1502, a PDU session associated with a first network slice (slice 1) and a second network slice (slice 2) may be deployed in the first DU 1508 and the second DU 1510, respectively, where the DUs are controlled by the same CU (CU 1512). In this case, separate access resources are allocated for the two network slices. For example, the UE 1506 may establish a connection 1520 via the first DU 1508 for slice 1 and establish a connection 1522 via the second DU 1510 for slice 2. In some examples, a shared N3 tunnel or individual N3 tunnels could be used for the two network slices. For a shared N3 tunnel, a slice index can be carried with the packet over the N3 tunnel. When service for slice 2 arrives (e.g., as discussed above), the CU 1512 establishes context (e.g., AS context) and resources in the second DU 1510 and suspends or releases the old context in the first DU 1508. In this case, the PDU session NAS context and the N3 tunnel may be maintained (e.g., not terminated). In some aspects, this approach may reduce signalling overhead.

The wireless communication system 1504 includes a user equipment (UE) 1526, a first gNB (RAN1) 1528, a second gNB (RAN2) 1530, an AMF 1532, an SMF 1534, and a PSA UPF 1536. In some examples, the UE 1526 may correspond to any of the UEs or scheduled entities shown in any of FIGS. 1, 2, 4, 5, 6, 7, 9, 11, 12, 13, 14, and 16. In some examples, the first gNB (RAN1) 1528 and the second gNB (RAN2) 1530 may correspond to any of the base stations or scheduling entities shown in any of FIGS. 1, 2, 4, 5, 8, 9, 11, 12, 13, 14, and 18. In some examples, the AMF 1532 may correspond to any of the AMF entities shown in any of FIGS. 4, 12, and 14. In some examples, the SMF 1534 may correspond to any of the SMF entities shown in any of FIGS. 4, 12, and 14. In some examples, the UPF 1536 may correspond to any of the UPF entities shown in any of FIGS. 4, 12, and 14.

In the wireless communication system 1504, a PDU session associated with a first network slice (slice 1) and a second network slice (slice 2) may be deployed in the first gNB (RAN1) 1528 and the second gNB (RAN2) 1530, respectively. In this case, separate access resources are allocated for the two network slices. For example, the UE 1526 may establish a connection 1538 via the first gNB (RAN1) 1528 for slice 1 and establish a connection 1540 via the second gNB (RAN2) 1530 for slice 2. When service for slice 2 arrives (e.g., as discussed above), the AMF 1532 and the SMF 1534 establish AN context and resources in the second gNB (RAN2) 1530 and suspend or release the old AN context in the first gNB (RAN1) 1528. In this case, the PDU session NAS context may be maintained (e.g., not terminated). In some aspects, this approach may reduce signalling overhead.

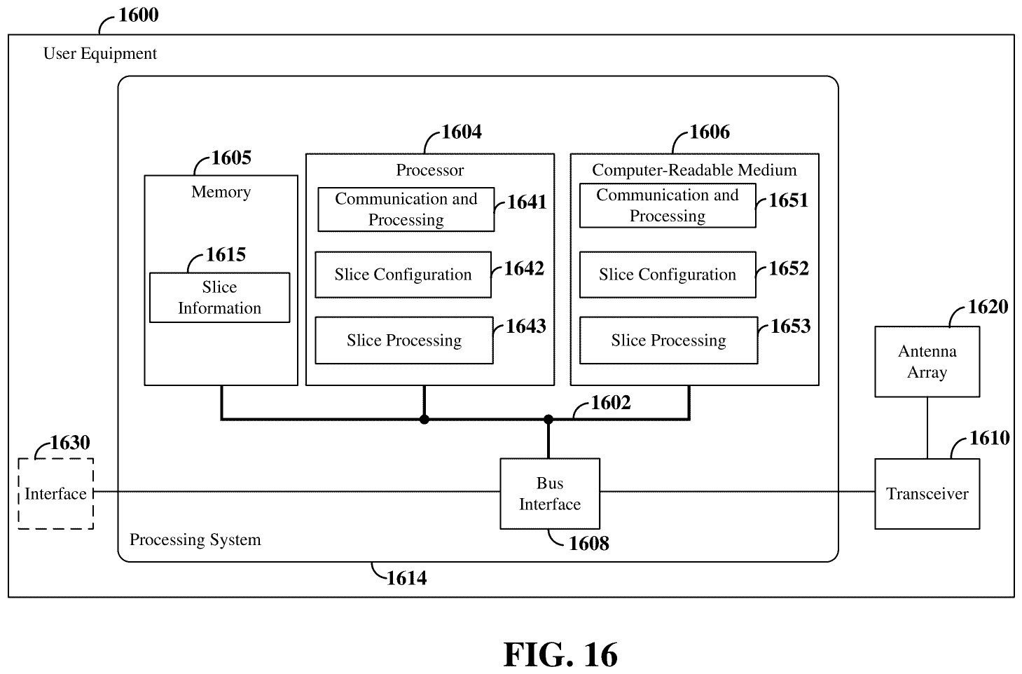

FIG. 16 is a block diagram illustrating an example of a hardware implementation for a UE 1600 employing a processing system 1614. For example, the UE 1600 may be a device configured to wirelessly communicate with a base station, as discussed in any one or more of FIGS. 1-15. In some implementations, the UE 1600 may correspond to any of the UEs or scheduled entities shown in any of FIGS. 1, 2, 4, 5, 6, 7, 9, 11, 12, 13, 14, and 15.

In accordance with various aspects of the disclosure, an element, or any portion of an element, or any combination of elements may be implemented with the processing system 1614. The processing system 1614 may include one or more processors 1604. Examples of processors 1604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1600 may be configured to perform any one or more of the functions described herein. That is, the processor 1604, as utilized in a UE 1600, may be used to implement any one or more of the processes and procedures described herein.

The processor 1604 may in some instances be implemented via a baseband or modem chip and in other implementations, the processor 1604 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1614 may be implemented with a bus architecture, represented generally by the bus 1602. The bus 1602 may include any number of interconnecting buses and bridges depending on the specific application of the processing system 1614 and the overall design constraints. The bus 1602 communicatively couples together various circuits including one or more processors (represented generally by the processor 1604), a memory 1605, and computer-readable media (represented generally by the computer-readable medium 1606). The bus 1602 may also link various other circuits such as timing sources, peripherals, voltage regulators, and power management circuits, which are well known in the art, and therefore, will not be described any further. A bus interface 1608 provides an interface between the bus 1602 and a transceiver 1610 and between the bus 1602 and an interface 1630. The transceiver 1610 provides a communication interface or means for communicating with various other apparatus over a wireless transmission medium. In some examples, the UE may include two or more transceivers 1610. The interface 1630 provides a communication interface or means of communicating with various other apparatuses and devices (e.g., other devices housed within the same apparatus as the UE or other external apparatuses) over an internal bus or external transmission medium, such as an Ethernet cable. Depending upon the nature of the apparatus, the interface 1630 may include a user interface (e.g., keypad, display, speaker, microphone, joystick). Of course, such a user interface is optional, and may be omitted in some examples, such as an IoT device.

The processor 1604 is responsible for managing the bus 1602 and general processing, including the execution of software stored on the computer-readable medium 1606. The software, when executed by the processor 1604, causes the processing system 1614 to perform the various functions described below for any particular apparatus. The computer-readable medium 1606 and the memory 1605 may also be used for storing data that is manipulated by the processor 1604 when executing software. For example, the memory 1605 may store slice information 1615 (e.g., PDU session-related parameters) used by the processor 1604 in cooperation with the transceiver 1610 for transmitting and/or receiving data associated with a network slice.

One or more processors 1604 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1606.

The computer-readable medium 1606 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1606 may reside in the processing system 1614, external to the processing system 1614, or distributed across multiple entities including the processing system 1614. The computer-readable medium 1606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

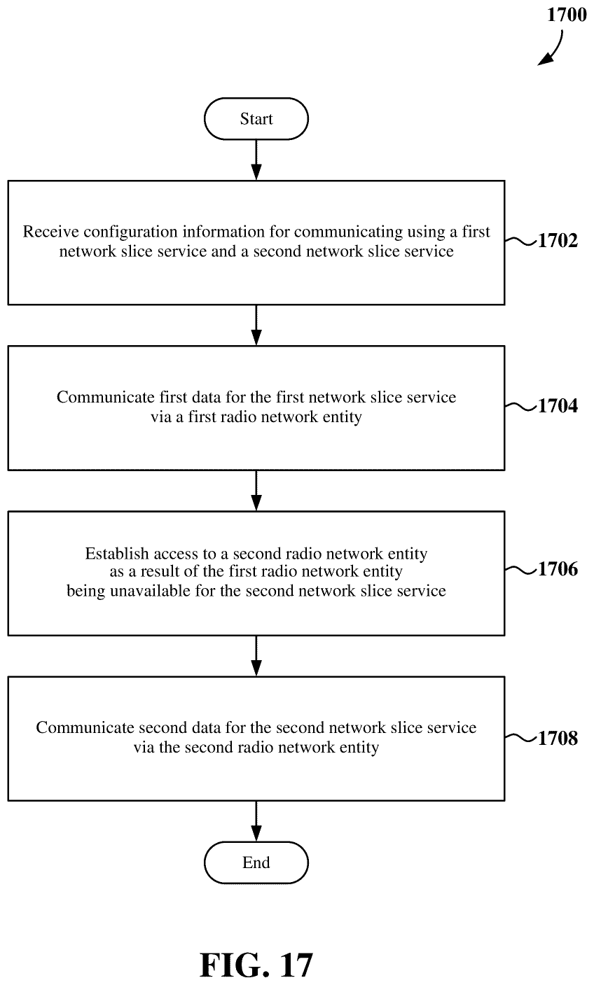

The UE 1600 may be configured to perform any one or more of the operations described herein (e.g., as described above in conjunction with FIGS. 1-15 and as described below in conjunction with FIG. 17). In some aspects of the disclosure, the processor 1604, as utilized in the UE 1600, may include circuitry configured for various functions.

The processor 1604 may include communication and processing circuitry 1641.

The communication and processing circuitry 1641 may be configured to communicate with a base station, such as a gNB. The communication and processing circuitry 1641 may include one or more hardware components that provide the physical structure that performs various processes related to wireless communication (e.g., signal reception and/or signal transmission) as described herein. The communication and processing circuitry 1641 may further include one or more hardware components that provide the physical structure that performs various processes related to signal processing (e.g., processing a received signal and/or processing a signal for transmission) as described herein. In some examples, the communication and processing circuitry 1641 may include two or more transmit/receive chains, each configured to process signals in a different RAT (or RAN) type. The communication and processing circuitry 1641 may further be configured to execute communication and processing software 1651 included on the computer-readable medium 1606 to implement one or more functions described herein.

In some implementations where the communication involves receiving information, the communication and processing circuitry 1641 may obtain information from a component of the UE 1600 (e.g., from the transceiver 1610 that receives the information via radio frequency signaling or some other type of signaling suitable for the applicable communication medium), process (e.g., decode) the information, and output the processed information. For example, the communication and processing circuitry 1641 may output the information to another component of the processor 1604, to the memory 1605, or to the bus interface 1608. In some examples, the communication and processing circuitry 1641 may receive one or more of signals, messages, other information, or any combination thereof. In some examples, the communication and processing circuitry 1641 may receive information via one or more channels. In some examples, the communication and processing circuitry 1641 may include functionality for a means for receiving. In some examples, the communication and processing circuitry 1641 may include functionality for a means for decoding.

In some implementations where the communication involves sending (e.g., transmitting) information, the communication and processing circuitry 1641 may obtain information (e.g., from another component of the processor 1604, the memory 1605, or the bus interface 1608), process (e.g., encode) the information, and output the processed information. For example, the communication and processing circuitry 1641 may output the information to the transceiver 1610 (e.g., that transmits the information via radio frequency signaling or some other type of signaling suitable for the applicable communication medium). In some examples, the communication and processing circuitry 1641 may send one or more of signals, messages, other information, or any combination thereof. In some examples, the communication and processing circuitry 1641 may send information via one or more channels. In some examples, the communication and processing circuitry 1641 may include functionality for a means for sending (e.g., a means for transmitting). In some examples, the communication and processing circuitry 1641 may include functionality for a means for encoding.

The processor 1604 may include slice configuration circuitry 1642 configured to perform network slice configuration-related operations as discussed herein (e.g., one or more of the operations described in conjunction with FIGS. 6-15). The slice configuration circuitry 1642 may be configured to execute slice configuration software 1652 included on the computer-readable medium 1606 to implement one or more functions described herein.

The slice configuration circuitry 1642 may include functionality for a means for receiving configuration information (e.g., as described in conjunction with #1 and/or #2 of FIG. 9 and/or #1 and/or #2 of FIG. 12 and/or #1 and/or #2 of FIG. 13 and/or block 1702 of FIG. 17). For example, the slice configuration circuitry 1642 may be configured to receive configuration information (e.g., in an RRC configuration message) from a gNB via a scheduled downlink resource (e.g., a PDSCH).

The processor 1604 may include slice processing circuitry 1643 configured to perform slice processing-related operations as discussed herein (e.g., one or more of the operations described in conjunction with FIGS. 6-15). The slice processing circuitry 1643 may be configured to execute slice processing software 1653 included on the computer-readable medium 1606 to implement one or more functions described herein.

The slice processing circuitry 1643 may include functionality for a means for communicating data for a network slice service via a radio network entity such as a distributed unit or a cell (e.g., as described in conjunction with #0 of FIG. 9 and/or #0 of FIG. 11 and/or #0 of FIG. 12 and/or #0 of FIG. 13 and/or connection 1520, 1522, 1538, or 1540 of FIG. 15, and/or block 1704 of FIG. 17 and/or block 1708 of FIG. 17). For example, the slice processing circuitry 1643 may be configured to transmit and/or receive data via resources allocated by a network for the network slice service.

The slice processing circuitry 1643 may include functionality for a means for establishing access to a radio network entity such as a distributed unit or a cell (e.g., as described in conjunction with #3 of FIG. 9 and/or #3 of FIG. 12 and/or #3 of FIG. 13 and/or block 1706 of FIG. 17). For example, the slice processing circuitry 1643 may be configured to, upon determining that an application on the UE 1600 is to receive or transmit data for a particular network slice, cause a message to be transmitted to a network, where the message includes information about the network slice service and a distributed unit or a cell that supports the network slice service.

FIG. 17 is a flow chart illustrating an example method 1700 for wireless communication according to some aspects of the disclosure. As described herein, some or all illustrated features may be omitted in a particular implementation within the scope of the present disclosure, and some illustrated features may not be required for implementation of all examples. In some examples, the method 1700 may be carried out by the UE 1600 illustrated in FIG. 16. In some examples, the method 1700 may be carried out by any suitable apparatus or means for carrying out the functions or algorithm described below.

At block 1702, a user equipment may receive configuration information for communicating using a first network slice service and a second network slice service. For example, the slice configuration circuitry 1642 together with the communication and processing circuitry 1641 and the transceiver 1610, shown and described above in connection with FIG. 16, may provide a means to receive configuration information for communicating using a first network slice service and a second network slice service.

At block 1704, the user equipment may communicate first data for the first network slice service via a first radio network entity. For example, the slice processing circuitry 1643 together with the communication and processing circuitry 1641 and the transceiver 1610, shown and described above in connection with FIG. 16, may provide a means to communicate first data for the first network slice service via a first radio network entity.

In some examples, the first radio network entity may be a first distributed unit. In some examples, the first radio network entity may be a first cell. In some examples, the first radio network entity may be a first base station.

In some examples, communicating first data for the first network slice service via a first radio network entity may include transmitting the first data for the first network slice service to the first radio network entity (e.g., a first distributed unit, a first cell, or a first base station). In some examples, communicating first data for the first network slice service via a first radio network entity may include receiving the first data for the first network slice service from the first radio network entity (e.g., a first distributed unit, a first cell, or a first base station).

At block 1706, the user equipment may establish access to a second radio network entity as a result of the first radio network entity being unavailable for the second network slice service. For example, the slice processing circuitry 1643 together with the communication and processing circuitry 1641 and the transceiver 1610, shown and described above in connection with FIG. 16, may provide a means to establish access to a second radio network entity as a result of the first radio network entity being unavailable for the second network slice service.

In some examples, the second radio network entity may be a second distributed unit. In some examples, the second radio network entity may be a second cell. In some examples, the second radio network entity may be a second base station.

In some examples, the first radio network entity being unavailable for the second network slice service may include the first radio network entity not supporting the second network slice service. In some examples, the first radio network entity being unavailable for the second network slice service may include the first radio network entity not being configured for the second network slice service. In some examples, the first radio network entity being unavailable for the second network slice service may include a radio access network condition (e.g., radio access network overload) that results in the second network slice service not being available to a UE via the first radio network entity. Other examples of the first radio network entity being unavailable for the second network slice service may occur in other scenarios.

At block 1708, the user equipment may communicate second data for the second network slice service via the second radio network entity. For example, the slice processing circuitry 1643 together with the communication and processing circuitry 1641 and the transceiver 1610, shown and described above in connection with FIG. 16, may provide a means to communicate second data for the second network slice service via the second radio network entity.

In some examples, communicating second data for the second network slice service via the second radio network entity may include transmitting the second data for the second network slice service to the second radio network entity (e.g., a second distributed unit, a second cell, or a second base station). In some examples, communicating second data for the second network slice service via the second radio network entity may include receiving the second data for the second network slice service from the second radio network entity (e.g., a second distributed unit, a second cell, or a second base station).

In some examples, the user equipment may use a first protocol data unit (PDU) session for the first network slice service. In some examples, the user equipment may use a second PDU session for the second network slice service.

In some examples, the user equipment may use a first protocol data unit (PDU) session for the first network slice service and the second network slice service. In some examples the first PDU session is remapped from the first network slice service to the second network slice service in conjunction with the establishment of the access to the second radio network entity.

In some examples, the user equipment may transmit a first message identifying the second network slice service and identifying at least one candidate radio network entity. In some examples, the user equipment may receive a second message specifying that the second radio network entity has been selected for the second network slice service.

In some examples, the user equipment may transmit a first message identifying at least one candidate radio network entity that supports the second network slice service. In some examples, the user equipment may receive a second message specifying that the second radio network entity has been selected for the second network slice service.

In some examples, the user equipment may transmit a message requesting that the user equipment be handed-over to a radio network entity that supports the second network slice service.

In some examples, user equipment context for the first network slice service is suspended in conjunction with the establishment of the access to the second radio network entity.

In some examples, a protocol data unit (PDU) session is associated with the first network slice service and the second network slice service. In some examples, a first access resource is allocated for the first network slice service. In some examples, a second access resource is allocated for the second network slice service.

In some examples, the first radio network entity comprises a first distributed unit. In some examples, the second radio network entity comprises a second distributed unit. In some examples, the first distributed unit is controlled by a first control unit. In some examples, the second distributed unit is controlled by the first control unit.

In some examples, the first radio network entity comprises a first cell. In some examples, the second radio network entity comprises a second cell. In some examples, the first cell is served by a first base station. In some examples, the second cell is served by a second base station.

In one configuration, the UE 1600 includes means for receiving configuration information for communicating using a first network slice service and a second network slice service, means for communicating first data for the first network slice service via a first radio network entity, means for establishing access to a second radio network entity as a result of the first radio network entity being unavailable for the second network slice service, and means for communicating second data for the second network slice service via the second radio network entity. In one aspect, the aforementioned means may be the processor 1604 shown in FIG. 16 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1604 is merely provided as an example, and other means for carrying out the described functions may be included within various aspects of the present disclosure, including but not limited to the instructions stored in the computer-readable medium 1606, or any other suitable apparatus or means described in any one or more of FIGS. 1, 2, 4, 5, 6, 7, 9, 11, 12, 13, 14, 15, and 16, and utilizing, for example, the methods and/or algorithms described herein in relation to FIG. 17.

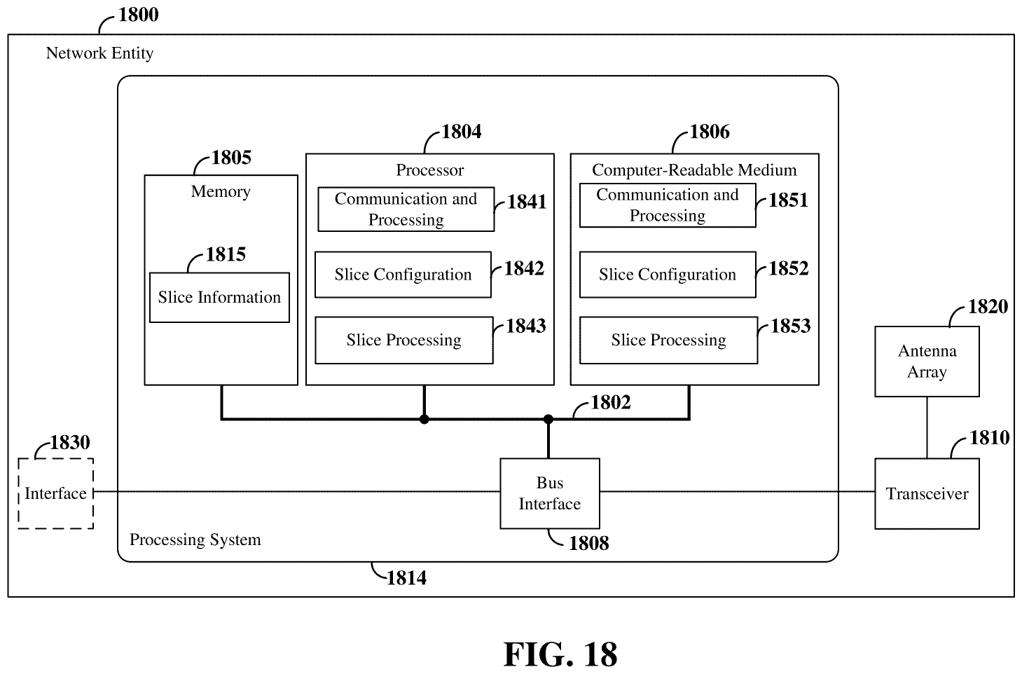

FIG. 18 is a conceptual diagram illustrating an example of a hardware implementation for network entity 1800 employing a processing system 1814. In some implementations, the network entity 1800 may correspond to any of the BSs (e.g., gNBs), scheduling entities, distributed units, control units, RAN nodes, or CN entities, shown in any of FIGS. 1, 2, 4, 5, 8, 9, 11, 12, 13, 14, and 15.

In accordance with various aspects of the disclosure, an element, or any portion of an element, or any combination of elements may be implemented with the processing system 1814. The processing system may include one or more processors 1804. The processing system 1814 may be substantially the same as the processing system 1614 illustrated in FIG. 16, including a bus interface 1808, a bus 1802, memory 1805, a processor 1804, and a computer-readable medium 1806. The memory 1805 may store slice information 1815 (e.g., PDU session-related parameters) used by the processor 1804 in cooperation with the transceiver 1810 for transmitting and/or receiving data associated with a network slice. Furthermore, the network entity 1800 may include an interface 1830 (e.g., a network interface) that provides a means for communicating with at least one other apparatus within a core network and with at least one radio access network.

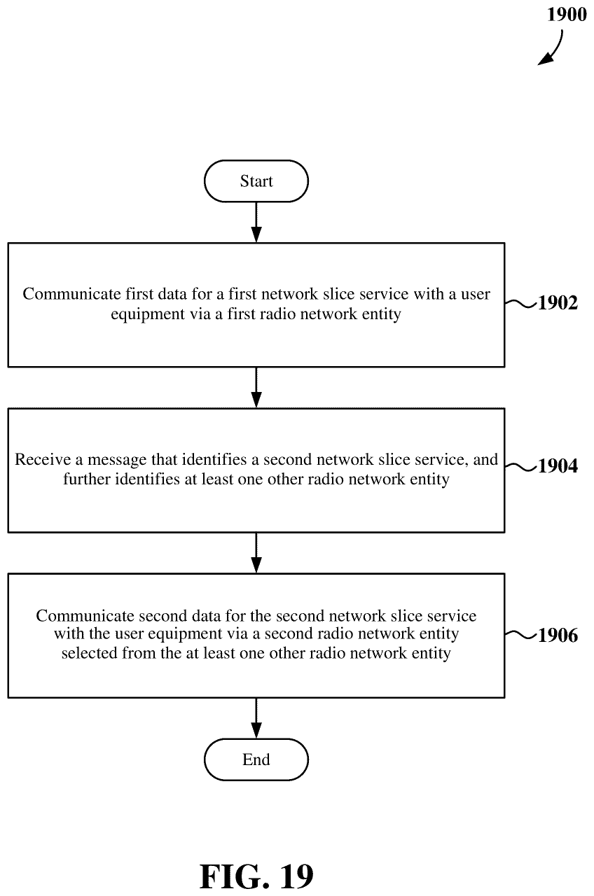

The network entity 1800 may be configured to perform any one or more of the operations described herein (e.g., as described above in conjunction with FIGS. 1-15 and as described below in conjunction with FIG. 19). In some aspects of the disclosure, the processor 1804, as utilized in the network entity 1800, may include circuitry configured for various functions.

The processor 1804 may be configured to generate, schedule, and modify a resource assignment or grant of time-frequency resources (e.g., a set of one or more resource elements). For example, the processor 1804 may schedule time-frequency resources within a plurality of time division duplex (TDD) and/or frequency division duplex (FDD) subframes, slots, and/or mini-slots to carry user data traffic and/or control information to and/or from multiple UEs.

The processor 1804 may further be configured to schedule resources for the transmission of an uplink signal. The processor 1804 may be configured to schedule uplink resources that may be utilized by the UE to transmit an uplink message (e.g., a PUCCH, a PUSCH, a PRACH occasion, or an RRC message). In some examples, the processor 1804 may be configured to schedule uplink resources in response to receiving a scheduling request from the UE.

In some aspects of the disclosure, the processor 1804 may include communication and processing circuitry 1841. The communication and processing circuitry 1844 may be configured to communicate with a UE. The communication and processing circuitry 1841 may include one or more hardware components that provide the physical structure that performs various processes related to communication (e.g., signal reception and/or signal transmission) as described herein. The communication and processing circuitry 1841 may further include one or more hardware components that provide the physical structure that performs various processes related to signal processing (e.g., processing a received signal and/or processing a signal for transmission) as described herein. The communication and processing circuitry 1841 may further be configured to execute communication and processing software 1851 included on the computer-readable medium 1806 to implement one or more functions described herein.

In some implementations wherein the communication involves receiving information, the communication and processing circuitry 1841 may obtain information from a component of the network entity 1800 (e.g., from the transceiver 1810 that receives the information via radio frequency signaling or some other type of signaling suitable for the applicable communication medium), process (e.g., decode) the information, and output the processed information. For example, the communication and processing circuitry 1841 may output the information to another component of the processor 1804, to the memory 1805, or to the bus interface 1808. In some examples, the communication and processing circuitry 1841 may receive one or more of signals, messages, other information, or any combination thereof. In some examples, the communication and processing circuitry 1841 may receive information via one or more channels. In some examples, the communication and processing circuitry 1841 may include functionality for a means for receiving. In some examples, the communication and processing circuitry 1841 may include functionality for a means for decoding.

In some implementations wherein the communication involves sending (e.g., transmitting) information, the communication and processing circuitry 1841 may obtain information (e.g., from another component of the processor 1804, the memory 1805, or the bus interface 1808), process (e.g., encode) the information, and output the processed information. For example, the communication and processing circuitry 1841 may output the information to the transceiver 1810 (e.g., that transmits the information via radio frequency signaling or some other type of signaling suitable for the applicable communication medium). In some examples, the communication and processing circuitry 1841 may send one or more of signals, messages, other information, or any combination thereof. In some examples, the communication and processing circuitry 1841 may send information via one or more channels. In some examples, the communication and processing circuitry 1841 may include functionality for a means for sending (e.g., a means for transmitting). In some examples, the communication and processing circuitry 1841 may include functionality for a means for encoding.

The processor 1804 may include slice configuration circuitry 1842 configured to perform network slice configuration-related operations as discussed herein (e.g., one or more of the operations described in conjunction with FIGS. 6-15). The slice configuration circuitry 1842 may be configured to execute slice configuration software 1852 included on the computer-readable medium 1806 to implement one or more functions described herein.

The slice configuration circuitry 1842 may include functionality for a means for receiving a message that identifies a network slice service, and further identifies at least one radio network entity (e.g., as described in conjunction with #3 of FIG. 9 and/or #3 of FIG. 12 and/or #3 of FIG. 13 and/or block 1704 of FIG. 17). For example, the slice configuration circuitry 1842 may be configured to receive a message from a user equipment that includes information about the network slice service and a distributed unit or a cell that supports the network slice service.

The processor 1804 may include slice processing circuitry 1843 configured to perform slice processing-related operations as discussed herein (e.g., one or more of the operations described in conjunction with FIGS. 6-15). The slice processing circuitry 1843 may be configured to execute slice processing software 1853 included on the computer-readable medium 1806 to implement one or more functions described herein.

The slice processing circuitry 1843 may include functionality for a means for communicating data for a network slice service with a user equipment via a radio network entity such as a distributed unit or a cell (e.g., as described in conjunction with #0 of FIG. 9 and/or #0 of FIG. 11 and/or #0 of FIG. 12 and/or #0 of FIG. 13 and/or connection 1520, 1522, 1538, or 1540 of FIG. 15, and/or block 1902 of FIG. 19 and/or block 1906 of FIG. 19). For example, the slice processing circuitry 1843 may be configured to control the sending and/or receiving of data via resources allocated by the network entity 1800 for the network slice service.

FIG. 19 is a flow chart illustrating an example method 1900 for wireless communication according to some aspects of the disclosure. As described herein, some or all illustrated features may be omitted in a particular implementation within the scope of the present disclosure, and some illustrated features may not be required for implementation of all examples. In some examples, the method 1900 may be carried out by the network entity 1800 illustrated in FIG. 18. In some examples, the method 1900 may be carried out by any suitable apparatus or means for carrying out the functions or algorithm described below.

At block 1902, a network entity may communicate first data for a first network slice service with a user equipment via a first radio network entity. For example, the slice processing circuitry 1843 together with the communication and processing circuitry 1841 and the transceiver 1810, shown and described above in connection with FIG. 18, may provide a means to communicate first data for a first network slice service with a user equipment via a first radio network entity.

In some examples, the first radio network entity may be a first distributed unit. In some examples, the first radio network entity may be a first cell. In some examples, the first radio network entity may be a first base station.

In some examples, communicating first data for a first network slice service with a user equipment via a first radio network entity may include transmitting the first data for the first network slice service to the user equipment via the first radio network entity (e.g., a first distributed unit, a first cell, or a first base station). In some examples, communicating first data for a first network slice service with a user equipment via a first radio network entity may include receiving the first data for the first network slice service from the user equipment via the first radio network entity (e.g., a first distributed unit, a first cell, or a first base station).

At block 1904, the network entity may receive a message that identifies a second network slice service, and further identifies at least one other radio network entity. For example, the slice configuration circuitry 1842 together with the communication and processing circuitry 1841 and the transceiver 1810, shown and described above in connection with FIG. 18, may provide a means to receive a message that identifies a second network slice service, and further identifies at least one other radio network entity.

In some examples, the at least one other radio network entity may be at least one other distributed unit. In some examples, the at least one other radio network entity may be at least one other cell. In some examples, the at least one other radio network entity may be at least one other base station.

At block 1906, the network entity may communicate second data for the second network slice service with the user equipment via a second radio network entity selected from the at least one other radio network entity. For example, the slice processing circuitry 1843 together with the communication and processing circuitry 1841 and the transceiver 1810, shown and described above in connection with FIG. 18, may provide a means to communicate second data for the second network slice service with the user equipment via a second radio network entity selected from the at least one other radio network entity.

In some examples, communicating second data for the second network slice service with the user equipment via a second radio network entity may include transmitting the second data for the second network slice service to the user equipment via the second radio network entity (e.g., a second distributed unit, a second cell, or a second base station). In some examples, communicating second data for the second network slice service with the user equipment via a second radio network entity may include receiving the second data for the second network slice service from the user equipment via the second radio network entity (e.g., a second distributed unit, a second cell, or a second base station).

In some examples, the network entity may establish a first protocol data unit (PDU) session for the first network slice service. In some examples, the network entity may establish a second PDU session for the second network slice service.

In some examples, the network entity may establish a first protocol data unit (PDU) session for the first network slice service and the second network slice service. In some examples, the network entity may remap the first PDU session for the first network slice service to the second network slice service in conjunction with establishing access between the user equipment and the second radio network entity.

In some examples, the network entity may receive a first message identifying the second network slice service and identifying at least one candidate radio network entity. In some examples, the network entity may transmit a second message specifying that the second radio network entity has been selected for the second network slice service.

In some examples, the network entity may receive a first message identifying at least one candidate radio network entity that supports the second network slice service. In some examples, the network entity may transmit a second message specifying that the second radio network entity has been selected for the second network slice service.

In some examples, the network entity may suspend user equipment context for the first network slice service in conjunction with establishing access between the user equipment and the second radio network entity.

In some examples, the network entity may terminate the second network slice service. In some examples, the network entity may suspend user equipment context for the second network slice service on the second radio network entity. In some examples, the network entity may resume user equipment context for the first network slice service on the first radio network entity.

In some examples, the network entity may terminate the second network slice service. In some examples, the network entity may suspend user equipment context for the second network slice service on the second radio network entity. In some examples, the network entity may switch user equipment context for the first network slice service to the second radio network entity.

In some examples, the network entity may establish a protocol data unit (PDU) session that is associated with the first network slice service and the second network slice service. In some examples, the network entity may allocate a first access resource for the first network slice service. In some examples, the network entity may allocate a second access resource for the second network slice service.

In some examples, the network entity may, in conjunction with establishing access between the user equipment and the second radio network entity, establish access stratum (AS) context and resources in the second radio network entity. In some examples, the network entity may, in conjunction with establishing access between the user equipment and the second radio network entity, maintain non-access stratum (NAS) context for the PDU session in the second radio network entity.

In some examples, the network entity may, in conjunction with establishing access between the user equipment and the second radio network entity, release access stratum (AS) context and resources in the first radio network entity. In some examples, the network entity may, in conjunction with establishing access between the user equipment and the second radio network entity, maintain non-access stratum (NAS) context for the PDU session in the second radio network entity.

In one configuration, the network entity 1800 includes means for communicating first data for a first network slice service with a user equipment via a first radio network entity, means for receiving a message that identifies a second network slice service, and further identifies at least one other radio network entity, and means for communicating second data for the second network slice service with the user equipment via a second radio network entity selected from the at least one other radio network entity. In one aspect, the aforementioned means may be the processor 1804 shown in FIG. 18 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable medium 1806, or any other suitable apparatus or means described in any one or more of FIGS. 1, 2, 4, 5, 8, 9, 11, 12, 13, 14, 15, and 18, and utilizing, for example, the methods and/or algorithms described herein in relation to FIG. 19.

The methods shown in FIGS. 17 and 19 may include additional aspects, such as any single aspect or any combination of aspects described below and/or in connection with one or more other processes described elsewhere herein. The following provides an overview of several aspects of the present disclosure.

Aspect 1: A method for wireless communication at a user equipment, the method comprising: receiving configuration information for communicating using a first network slice service and a second network slice service; communicating first data for the first network slice service via a first radio network entity; establishing access to a second radio network entity as a result of the first radio network entity being unavailable for the second network slice service; and communicating second data for the second network slice service via the second radio network entity.

Aspect 2: The method of aspect 1, further comprising: using a first protocol data unit (PDU) session for the first network slice service; and using a second PDU session for the second network slice service.

Aspect 3: The method of aspect 1, further comprising: using a first protocol data unit (PDU) session for the first network slice service and the second network slice service.

Aspect 4: The method of aspect 3, wherein the first PDU session is remapped from the first network slice service to the second network slice service in conjunction with the establishment of the access to the second radio network entity.

Aspect 5: The method of any of aspects 1 through 4, further comprising: transmitting a first message identifying the second network slice service and identifying at least one candidate radio network entity; and receiving, a second message specifying that the second radio network entity has been selected for the second network slice service.

Aspect 6: The method of any of aspects 1 through 5, further comprising: transmitting a first message identifying at least one candidate radio network entity that supports the second network slice service; and receiving a second message specifying that the second radio network entity has been selected for the second network slice service.

Aspect 7: The method of any of aspects 1 through 6, further comprising: transmitting a message requesting that the user equipment be handed-over to a radio network entity that supports the second network slice service.

Aspect 8: The method of any of aspects 1 through 7, wherein user equipment context for the first network slice service is suspended in conjunction with the establishment of the access to the second radio network entity.

Aspect 9: The method of any of aspects 1 and 4 through 8, wherein: a protocol data unit (PDU) session is associated with the first network slice service and the second network slice service; a first access resource is allocated for the first network slice service; and a second access resource is allocated for the second network slice service.

Aspect 10: The method of aspect 9, wherein: the first radio network entity comprises a first distributed unit; the second radio network entity comprises a second distributed unit; the first distributed unit is controlled by a first control unit; and the second distributed unit is controlled by the first control unit.

Aspect 11: The method of aspect 9, wherein: the first radio network entity comprises a first cell; the second radio network entity comprises a second cell; the first cell is served by a first base station; and the second cell is served by a second base station.

Aspect 12: The method of any of aspects 1 through 11, wherein the first radio network entity being unavailable for the second network slice service comprises the first radio network entity not supporting the second network slice service.

Aspect 13: The method of any of aspects 1 through 11, wherein the first radio network entity being unavailable for the second network slice service comprises the first radio network entity not being configured for the second network slice service.

Aspect 17: A method for wireless communication at a network entity, the method comprising: communicating first data for a first network slice service with a user equipment via a first radio network entity; receiving a message that identifies a second network slice service, and further identifies at least one other radio network entity; and communicating second data for the second network slice service with the user equipment via a second radio network entity selected from the at least one other radio network entity.

Aspect 18: The method of aspect 17, further comprising: establishing a first protocol data unit (PDU) session for the first network slice service; and establishing a second PDU session for the second network slice service.

Aspect 19: The method of aspect 17, further comprising: establishing a first protocol data unit (PDU) session for the first network slice service and the second network slice service; and remapping the first PDU session for the first network slice service to the second network slice service in conjunction with establishing access between the user equipment and the second radio network entity.

Aspect 20: The method of any of aspects 17 through 19, further comprising: receiving a first message identifying the second network slice service and identifying at least one candidate radio network entity; and transmitting a second message specifying that the second radio network entity has been selected for the second network slice service.

Aspect 21: The method of any of aspects 17 through 19, further comprising: receiving a first message identifying at least one candidate radio network entity that supports the second network slice service; and transmitting a second message specifying that the second radio network entity has been selected for the second network slice service.

Aspect 22: The method of any of aspects 17 through 21, further comprising: suspending user equipment context for the first network slice service in conjunction with establishing access between the user equipment and the second radio network entity.

Aspect 23: The method of any of aspects 17 through 22, further comprising: terminating the second network slice service; suspending user equipment context for the second network slice service on the second radio network entity; and resuming user equipment context for the first network slice service on the first radio network entity.

Aspect 24: The method of any of aspects 17 through 22, further comprising: terminating the second network slice service; suspending user equipment context for the second network slice service on the second radio network entity; and switching user equipment context for the first network slice service to the second radio network entity.

Aspect 25: The method of any of aspects 17 and 20 through 24, further comprising: establishing a protocol data unit (PDU) session that is associated with the first network slice service and the second network slice service; allocating a first access resource for the first network slice service; and allocating a second access resource for the second network slice service.

Aspect 26: The method of aspect 25, further comprising, in conjunction with establishing access between the user equipment and the second radio network entity: establishing access stratum (AS) context and resources in the second radio network entity; and maintaining non-access stratum (NAS) context for the PDU session in the second radio network entity.

Aspect 27: The method of aspect 25, further comprising, in conjunction with establishing access between the user equipment and the second radio network entity: releasing access stratum (AS) context and resources in the first radio network entity; and maintaining non-access stratum (NAS) context for the PDU session in the second radio network entity.

Aspect 30: A user equipment comprising: a transceiver configured to communicate with a radio access network, a memory, and a processor coupled to the transceiver and the memory, wherein the processor is configured to perform any one of aspects 1 through 13.

Aspect 31: An apparatus configured for wireless communication comprising at least one means for performing any one of aspects 1 through 13.

Aspect 32: A non-transitory computer-readable medium storing computer-executable code, comprising code for causing an apparatus to perform any one of aspects 1 through 13.

Aspect 33: A network entity comprising: a memory and a processor coupled to the memory, wherein the processor is configured to perform any one of aspects 17 through 27.

Aspect 34: An apparatus configured for wireless communication comprising at least one means for performing any one of aspects 17 through 27.

Aspect 35: A non-transitory computer-readable medium storing computer-executable code, comprising code for causing an apparatus to perform any one of aspects 17 through 27.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may encompass a wide variety of actions. For example, “determining” may include calculating, computing, processing, deriving, investigating, looking up (e.g., looking up in a table, a database or another data structure), ascertaining, resolving, selecting, choosing, establishing, receiving (e.g., receiving information), accessing (e.g., accessing data in a memory), and the like.

One or more of the components, steps, features and/or functions illustrated in FIGS. 1-19 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in any of FIGS. 1, 2, 4, 5, 6, 7, 8, 9, 11, 12, 13, 14, 15, 16, and 18 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment, comprising:
a transceiver; and
a processor coupled to the transceiver, wherein the processor is configured to:
receive configuration information for communicating using a first network service and a second network service;
communicate, via the transceiver, first data for the first network service via a first radio network entity;
establish, via the transceiver, access to a second radio network entity as a result of the first radio network entity being unavailable for the second network service; and
communicate, via the transceiver, second data for the second network service via the second radio network entity.

2. The user equipment of claim 1, wherein the processor is further configured to:
use a first protocol data unit (PDU) session for the first network service; and
use a second PDU session for the second network service.

3. The user equipment of claim 1, wherein the processor is further configured to:
use a first protocol data unit (PDU) session for the first network service and the second network service.

4. The user equipment of claim 3, wherein the first PDU session is remapped from the first network service to the second network service in conjunction with the establishment of the access to the second radio network entity.

5. The user equipment of claim 1, wherein the processor is further configured to:
transmit, via the transceiver, a first message identifying the second network service and identifying at least one candidate radio network entity; and
receive, via the transceiver, a second message specifying that the second radio network entity has been selected for the second network service.

6. The user equipment of claim 1, wherein the processor is further configured to:
transmit, via the transceiver, a first message identifying at least one candidate radio network entity that supports the second network service; and
receive, via the transceiver, a second message specifying that the second radio network entity has been selected for the second network service.

7. The user equipment of claim 1, wherein the processor is further configured to:
transmit, via the transceiver, a message requesting that the user equipment be handed-over to a radio network entity that supports the second network service.

8. The user equipment of claim 1, wherein user equipment context for the first network service is suspended in conjunction with the establishment of the access to the second radio network entity.

9. The user equipment of claim 1, wherein:
a protocol data unit (PDU) session is associated with the first network service and the second network service;
a first access resource is allocated for the first network service; and
a second access resource is allocated for the second network service.

10. The user equipment of claim 9, wherein:
the first radio network entity comprises a first distributed unit;
the second radio network entity comprises a second distributed unit;
the first distributed unit is controlled by a first control unit; and
the second distributed unit is controlled by the first control unit.

11. The user equipment of claim 9, wherein:
the first radio network entity comprises a first cell;
the second radio network entity comprises a second cell;
the first cell is served by a first base station; and
the second cell is served by a second base station.

12. The user equipment of claim 1, wherein the first radio network entity being unavailable for the second network service comprises the first radio network entity not supporting the second network service.

13. The user equipment of claim 1, wherein the first radio network entity being unavailable for the second network service comprises the first radio network entity not being configured for the second network service.

14. A method for wireless communication at a user equipment, the method comprising:
receiving configuration information for communicating using a first network service and a second network service;
communicating first data for the first network service via a first radio network entity;
establishing access to a second radio network entity as a result of the first radio network entity being unavailable for the second network service; and
communicating second data for the second network service via the second radio network entity.

15. The method of claim 14, further comprising:
using a first protocol data unit (PDU) session for the first network service; and
using a second PDU session for the second network service.

16. The method of claim 14, further comprising:
using a first protocol data unit (PDU) session for the first network service and the second network service.

17. A network entity, comprising:
a memory; and
a processor coupled to the memory, wherein the processor is configured to:
communicate first data for a first network service with a user equipment via a first radio network entity;
receive a message that identifies a second network service, and further identifies at least one other radio network entity; and
communicate second data for the second network service with the user equipment via a second radio network entity selected from the at least one other radio network entity.

18. The network entity of claim 17, wherein the processor is further configured to:
establish a first protocol data unit (PDU) session for the first network service; and
establish a second PDU session for the second network service.

19. The network entity of claim 17, wherein the processor is further configured to:
establish a first protocol data unit (PDU) session for the first network service and the second network service; and
remap the first PDU session for the first network service to the second network service in conjunction with establishing access between the user equipment and the second radio network entity.

20. The network entity of claim 17, wherein the processor is further configured to:
receive a first message identifying the second network service and identifying at least one candidate radio network entity; and
transmit a second message specifying that the second radio network entity has been selected for the second network service.

21. The network entity of claim 17, wherein the processor is further configured to:
receive a first message identifying at least one candidate radio network entity that supports the second network service; and
transmit a second message specifying that the second radio network entity has been selected for the second network service.

22. The network entity of claim 17, wherein the processor is further configured to:
suspend user equipment context for the first network service in conjunction with establishing access between the user equipment and the second radio network entity.

23. The network entity of claim 17, wherein the processor is further configured to:
terminate the second network service;
suspend user equipment context for the second network service on the second radio network entity; and
resume user equipment context for the first network service on the first radio network entity.

24. The network entity of claim 17, wherein the processor is further configured to:
terminate the second network service;
suspend user equipment context for the second network service on the second radio network entity; and
switch user equipment context for the first network service to the second radio network entity.

25. The network entity of claim 17, wherein the processor is further configured to:
establish a protocol data unit (PDU) session that is associated with the first network service and the second network service;
allocate a first access resource for the first network service; and
allocate a second access resource for the second network service.

26. The network entity of claim 25, wherein the processor is further configured to, in conjunction with establishing access between the user equipment and the second radio network entity:
establish access stratum (AS) context and resources in the second radio network entity; and
maintain non-access stratum (NAS) context for the PDU session in the second radio network entity.

27. The network entity of claim 25, wherein the processor is further configured to, in conjunction with establishing access between the user equipment and the second radio network entity:
release access stratum (AS) context and resources in the first radio network entity; and
maintain non-access stratum (NAS) context for the PDU session in the second radio network entity.

28. A method for wireless communication at a network entity, the method comprising:
communicating first data for a first network service with a user equipment via a first radio network entity;
receiving a message that identifies a second network service, and further identifies at least one other radio network entity; and
communicating second data for the second network service with the user equipment via a second radio network entity selected from the at least one other radio network entity.

29. The method of claim 28, further comprising:
receiving a first message identifying the second network service and identifying at least one candidate radio network entity; and
transmitting a second message specifying that the second radio network entity has been selected for the second network service.

30. The method of claim 28, further comprising:
receiving a first message identifying at least one candidate radio network entity that supports the second network service; and
transmitting a second message specifying that the second radio network entity has been selected for the second network service.
